(19) United States
(12) Patent Application Publication
(10) Pub. No.: US 2016/0312676 A1
(43) Pub. Date: Oct. 27, 2016

(54) MEMBRANE-BASED EXHAUST GAS SCRUBBING METHOD AND SYSTEM

(71) Applicant: IONADA INCORPORATED, Concord (CA)

(72) Inventors: Amir YOUSSEF, Toronto (CA); Thomas Franz Josef GEHRING, Toronto (CA); Steven HAI, Etobicoke (CA); Edoardo PANZIERA, King City (CA); John LEAVITT, Toronto (CA); Tim LIU, Concord (CA); Sanaz MOSADEGHSEDGHI, Concord (CA)

(21) Appl. No.: 15/203,687

(22) Filed: Jul. 6, 2016

Related U.S. Application Data
(63) Continuation-in-part of application No. 14/793,446, filed on Jul. 7, 2015.
Application No. 14/793,446 is a continuation-in-part of application No. 14/745,079, filed on Jun. 19, 2015, now Pat. No. 9,291,083.
Application No. 14/745,079 is a continuation of application No. PCT/CA2014/050359, filed on Apr. 8, 2014.
(60) Provisional application No. 61/835,288, filed on Jun. 14, 2013.
(60) Provisional application No. 62/296,214, filed on Feb. 17, 2016.

(30) Foreign Application Priority Data
Dec. 17, 2015 (CA) 2915675

(51) Int. Cl. F01N 3/08; F02M 26/35; B01D 53/22; C25B 1/16; B01D 71/02; B01D 53/14; C25B 1/22; F01N 3/20; B01D 69/08

(52) U.S. Cl. CPC F01N 3/0892; F01N 3/085; F01N 3/206; F02M 26/35; B01D 53/228; B01D 69/08; B01D 71/02; B01D 53/229; B01D 53/1425; B01D 53/1493; C25B 1/22; C25B 1/16; F01N 2610/01; B01D 2252/103; B01D 2311/06

(57) ABSTRACT

A method and apparatus to reduce emissions by gas membrane separation and liquid carrier chemical absorption. The membrane separation system consists of an absorption system containing ceramic membranes through which is circulated an absorbent carrier. Exhaust gases contact the exterior surface of the membranes and the target gasses permeate the membrane wall and are absorbed by the carrier(s) within the bore and thereby are removed from the exhaust stream. Various exemplary embodiments are described for systems to regenerate the carrier, and systems designed to remove SO₂ from the exhaust. One option uses an electrostatic charger to place a charge on the gas particles, while another uses a corona generator. In this aspect, the invention is also an improved electrostatic and corona separator, that uses a carrier liquid separated from the gas stream by a membrane to bear away undesirable particles instead of a deposit or collection plate or collection bag or similar device.

### CROSS-REFERENCE TO RELATED APPLICATIONS

This application is a continuation-in-part of co-pending U.S. application Ser. No. 14/793,446, filed on Jul. 7, 2015, which is a continuation-in-part of U.S. application Ser. No. 14/745,079, filed on Jun. 19, 2015, now issued as U.S. Pat. No. 9,291,083, which is a continuation of PCT application No. PCT/CA2014/050359 filed on Apr. 8, 2014, which claims the benefit of U.S. Provisional Application No. 61/835,288, filed on Jun. 14, 2013, the entire disclosures of which are incorporated herein by reference. This application also claims the benefit of U.S. Provisional Application No. 62/296,214, filed on Feb. 17, 2016, and Canadian Patent application No. 2,915,675 filed Dec. 17, 2015, the entire disclosures of which are incorporated herein by reference.

### TECHNICAL FIELD

The invention relates to processing of combustion gasses to remove contaminants such as oxides of sulfur, nitrogen and carbon. The invention has particular application to treating exhaust from combustion engines such as marine diesel engines.

### BACKGROUND

Marine diesel engines power the majority of ships used for marine transportation. These engines typically burn Heavy Fuel Oil (HFO), which contains high concentrations of sulfur and other impurities. The combustion process produces high concentrations of sulfur oxides (SOX), nitrogen oxides (NOX), carbon oxides (COX) such as CO₂, and other gases that are subject to increasing restrictions with new emerging emissions requirements.

One approach to reducing marine engine emissions is to switch to higher purified fuels, or distillates. These distillates are more expensive than HFO.

Another approach to reducing engine emissions is to inject H₂ (and O₂) gas, which is known to increase the combustion efficiency for heavy fuels and is sometimes used in engines in land-based transport. It is not generally used in water-based or marine transport engines, since the generation of H₂ (and O₂) gas is expensive and water-based transport is an extremely cost-sensitive enterprise. The benefits of hydrogen injection in marine applications is not generally pursued due to the high costs of generating the hydrogen. From a overall system point of view, the gains from increased combustion efficiency do not match the costs of generating the H₂ and O₂ gas. In the marine transport context, it is more important to have lower costs than to gain some small increase in transport speed—in some cases, ships' engines are deliberately de-rated (i.e, slowed down) to achieve cost savings.

An alternative approach is to post-treat, clean, or scrub the combustion exhaust gasses to remove undesirable emissions before they are discharged into the atmosphere.

Sea water scrubbers have been developed as a post-treatment solution to clean marine engine exhaust. A commonly used process is to spray aqueous alkaline or ammonia sorbents into the exhaust stream. However, these ‘wet’ sea water scrubbers can require large amounts of water and consequently generate large amounts of waste water, which can include metal salts such as calcium sulfate, soot, oils, and heavy metals. This can produce a toxic sludge that requires complex on board water treatment, and as well as disposal of sludge at designated ports. The resultant system is large, complex, expensive and energy intensive, increasing ship fuel consumption by as much as three percent. Although conventional sea water scrubber systems may be well suited for fixed land based power plants, they are simply too large and complex to operate efficiently in a marine application. As well, such systems may not be well suited to removing CO₂ from marine engine exhaust.

Treatment of marine exhaust could in principle be accomplished by modifying existing land-based technology to bubble marine exhaust gases through an ionic liquid. However, this approach may not be practical due to the high flow rates of marine exhaust and the resultant large volume of ionic liquid required, in light of the space and weight constraints of a marine vessel. The energy required to compress the exhaust gases to bubble through the ionic liquids could exceed the total energy available from the ship.

A system for scrubbing marine engine exhaust gasses using membrane technology has been proposed in Chinese patent No 200710012371.1. These approaches typically use polymeric membranes and pressurize the exhaust gas, and use the membrane as a filter. However, it is expensive to pressurize the exhaust gas, and depending upon the specific design such pressurization could also strain the engine through back-pressure.

An object of the present invention is to provide an improved method and system for reducing the concentration of one or more target emission gasses from a source such as a marine diesel engine.

Prior art separators that use electrostatic air filters or other electrostatic separation typically have a deposit or collection plate or a filter on which materials to be separated accumulate. This plate or filter must be replaced or cleaned to prevent fouling of the separation unit.

### SUMMARY

An alternative to the use of a conventional seawater scrubber for removing unwanted compounds from marine engine exhaust gas is to use membrane technology to separate and process one or more Target Emission Gasses (TEG's) such as SOX, NOX and/or COX from the exhaust gas. Advantages to using membranes over traditional solvent-based extraction processes such as sea water—based scrubbers include being potentially smaller, more energy- and cost-efficient and producing less waste water than a conventional water-based scrubber. Although membrane-based systems have been proposed in the past, the present invention relates to improvements that render such systems highly effective in a variety of applications including use with marine vessels.

An ionic liquid, used in association with an appropriate semipermeable membrane, can separate, capture and store a Target Emission Gas (TEG) such as SOX, NOX and/or COX from the exhaust gas in a closed loop reversible process. This alternative can eliminate or reduce the production of waste water and waste sludge in comparison with certain other solvents.

An ionic liquid (IL) is a solution that contains an organic cation (e.g. imidazolium, pyridinium, pyrrolidinium, phosphonium, ammonium), and a polyatomic inorganic anion (e.g. tetrafluoroborate, hexafluorophosphate, chloride) or an organic anion (e.g. trifluoromethylsulfonate, bis[(trifluoromethyl)sulfonyl]imide. The main advantages of ILs are their negligible volatility, non-flammability and good chemical and thermal stability. They are considered as environmental benign carriers as compared to volatile organic solvents, reducing the environmental risks of air pollution. Furthermore, certain properties of ILs (hydrophobicity, viscosity, solubility, acidity and basicity etc.) can be tuned to improve the solubility of one or more TEGs within the IL by selecting a specific combination of cation and anion and varied by altering the substitute group on the cation or the combined anion.

An ionic liquid may be “task specific.” An example of such a Task Specific Ionic Liquid (TSIL) is formed by the reaction of 1-butyl imidazole with 3-bromopropylamine hydrobromide, following a workup and anion exchange. This yields an ionic liquid active at room temperature, incorporating a cation with an appended amine group. The ionic liquid reacts reversibly with CO₂, reversibly sequestering the gas as a carbamate salt. The ionic liquid, which can be repeatedly recycled, is comparable in efficiency for CO₂ capture to commercial amine sequestering reagents and yet is nonvolatile and does not require water to function. The unique properties of ionic liquids make them particularly well-suited for physical and chemical absorption processes. They can be easily adjusted by substituting cations and anions in their structure and thereby “tuned” to absorb specific gases by either physical and or chemical absorption over specified processing conditions including temperature and pressure. These task specific ionic liquids provide significant improvements in chemical absorption efficiencies over other solvents

Ionic liquids have application in various liquid chemical separation processes. An example of an IL application is the BASIL (Biphasic Acid Scavenging utilizing Ionic Liquids) process developed by BASF, in which 1-alkylimidazole scavenges an acid from an existing process. IL compounds are also used in chemical synthesis such as the synthesis process for 2,5-dihydrofuran by Eastman and the difasol process, an IL-based process which is a modification to the dimersol process by which short chain alkenes are branched into alkenes of higher molecular weight. A further IL-based process is the Ionikylation process developed by Petrochina for the alkylation of four-carbon olefins with isobutane.

The invention is based on the principle that SOX, NOX, and/or COX can be selectively removed from marine exhaust gases by the use of a carrier circulated through a semi-permeable membrane system such as a ceramic membrane. These impurities are generally considered safe for discharge when dissolved into a liquid but should not be discharged as gasses into the atmosphere. With the use of a membrane to separate such compounds, the TEG can permeate through the membranes while particulates within the marine exhaust including ash, soot, and oils do not. The carriers remain clean and devoid of toxic impurities, and can be safely discharged, re-used, or regenerated.

A particular advantage of this approach is that the mass transfer of TEGs into the carrier can occur without pressurizing the exhaust gas. This approach relies on mass transfer down a concentration gradient between the exhaust and the carrier to extract TEGs from the exhaust gas.

The system according to the invention can be operated in an operating modes consisting of one of an Open Mode, a Closed Loop or a Zero Discharge mode.

The liquid carrier used in an Open Mode can be the water within which the vessel floats, which can be fresh water or sea water. The membrane separation system comprises an array of porous hollow fiber ceramic membranes in which fresh water or sea water circulates within the interiors of the membranes. The fresh water or sea water is drawn into the vessel from surrounding waters and is circulated through the hollow fiber membrane membranes. Flue gases pass over and contact the exterior of the porous hollow fiber membrane membranes and permeate through the membrane. One or more TEG's is absorbed by the water and removed from the exhaust stream. The absorbed gases form acids, which are neutralized by the hardness of the fresh water or salinity of the sea water as precipitates such as sulfides. The fresh water or sea water containing the precipitates is subsequently discharged into the surrounding waters of the ship.

The carrier used in a Closed Loop mode can be a basic solution such as sodium hydroxide, which is circulated through a hollow fiber membrane array. Flue gases contact the porous hollow fiber membrane and permeate through the membrane into the bore within which the carrier circulates. TEG's are absorbed by the solution within the membrane bore and thus removed from the exhaust stream. The absorbed gases form acids which are neutralized by the base. The heat absorbed by the carrier liquid as it passes through the membrane array elevates the carrier temperature and maintains the TEG compounds in solution. The carrier liquid can then be cooled within a desorption vessel, which causes the TEG compounds to precipitate in solid form such as sulfide precipitates. The precipitated solids can then be removed by a mechanical separation process such as filtering. The unsaturated carrier liquid can then be recirculated as a closed circulation loop. Cooling of the carrier liquid within the desorption vessel can be provided by use of a heat exchanged within the vessel in which ocean water is circulated as a cooling fluid.

The carrier used in a Zero Discharge mode can be an ionic liquid (IL) (for example, it can also be NaOH, KOH, or other carriers). The zero discharge mode comprises a closed loop reversible process. The membrane separation system comprises an array of porous hollow fiber ceramic membranes through which IL circulates and a desorption vessel (DV) for separating the TEG's from saturated IL. The sulfur dioxide, nitrogen oxides and carbon oxides can be separated from the ionic liquids within the DV by the application of one or more of differential pressure, temperature, and/or electric potential. The separated gases are then stored in pure states or as compounds, and the ionic liquid reused. The absorbed gases are stored and be used for commercial applications. The differential temperature required to dissociate the gases may be provided by the exhaust gases by means of a heat exchanger.

By means of the invention, exhaust gases permeate through the ceramic porous membranes but toxic particulates within the marine exhaust including ash, soot, and oils are too large to permeate through the membrane pores. The carriers remain clean and void of toxic impurities and can be safely discharged, re-used or regenerated in open loop, closed loop, or zero discharge modes. In contrast, conventional Wet Water Scrubbers may spray carriers directly into the marine exhaust. Toxic particulates become trapped and suspended within the carriers, and must be removed from the carriers using complex, energy intensive, and expensive cleaning systems. The cleaning process produces a sludge byproduct that is expensive to dispose of on land.

In accordance with the present invention, there is provided a method for reducing the concentration of a target emission gas (TEG) from an source of engine exhaust gas comprising the steps of: directing said engine exhaust gas from the source into an enclosed space containing at least one array of hollow fibre semi-permeable ceramic membranes, wherein said exhaust gas contacts an exterior surface of said membranes whereupon TEG within said exhaust gas permeate through said membrane thereby lowering the concentration of said TEG within said exhaust gas; circulating a regenerable carrier liquid capable of retaining said TEG through bores of said hollow fibre ceramic membranes thereby elevating the concentration of TEG compounds within said carrier liquid to create an exit liquid; discharging said exhaust gas containing a reduced TEG concentration from the enclosed space and removing said exit liquid containing said TEG compounds therein from said hollow fibre ceramic membrane array; using an evaporator to separate the exit liquid into a first liquid phase and a first gaseous phase where the first gaseous phase includes the TEG; using a condenser to separate the first gaseous phase into a second liquid phase and a second gaseous phase where the second gaseous phase includes the TEG; and mixing the first liquid phase and the second liquid phase to regenerate the first carrier liquid.

In an aspect of the present invention, negative pressure is applied to draw the exit liquid from the hollow fibre ceramic membrane array. In another aspect of the present invention, the carrier liquid is aqueous H3PO4+NaOH [symbol] Na2HPO4+2H2O. In another aspect of the present invention, the carrier liquid enters the enclosed space at a temperature of between 30 and 40 degrees Celsius. In another aspect of the present invention, the method further comprises the step of removing moisture from said engine exhaust gas before directing said engine exhaust gas from the source into an enclosed space containing at least one array of hollow fibre semi-permeable ceramic membranes. In another aspect of the present invention, the method further comprises the step of cooling said engine exhaust gas before directing said engine exhaust gas from the source into an enclosed space containing at least one array of hollow fibre semi-permeable ceramic membranes. In another aspect of the present invention, the method further comprises the method of claim 5 further comprising the step of cooling said engine exhaust gas before directing said engine exhaust gas from the source into an enclosed space containing at least one array of hollow fibre semi-permeable ceramic membranes. In another aspect of the present invention, the method further comprises the steps of determining the concentration of SO2 within untreated exhaust gas, determining an optimal rate of carrier liquid flow required to reduce the SO2 concentration in said untreated gas to a target level and selectively controlling the rate of liquid flow through said membrane array to match said optimal rate of liquid flow. In another aspect of the present invention, the method further comprises the step of determining the effectiveness of said membrane array at reducing the concentration of said SO2 in said exhaust gas by determining whether said liquid passing through said array experiences one or both of a pressure drop that exceeds a predetermined level or a pH drop that is less than a predetermined level. In another aspect of the present invention, the membrane array comprises a module housed in a module housing wherein said carrier liquid is circulated through a selected number of said modules based on a determination of the level of SO2 concentration in said exhaust gas and/or the flow rate of said exhaust gas and wherein said modules may be selectively activated or deactivated in response to said determination.

In accordance with the present invention, there is also provided a system for lowering the concentration of at least one target emission gas (TEG) from a source of engine exhaust gas comprising: an enclosure for receiving a stream of engine exhaust; a plurality of gas treatment modules configured for installation within said enclosure, each of said modules comprising a housing and an array of hollow fibre ceramic membranes supported within the housing and configured so that said exhaust contacts the membranes as the exhaust gas is circulated through the array when the module is installed within the enclosure, each of said ceramic membranes comprising a semi-permeable membrane wall which is permeable to said TEG in said emission gas and a hollow bore; a liquid inlet for feeding a carrier liquid into said membrane bores in an unsaturated state; a liquid outlet for receiving an exit liquid from said bores, said exit liquid being the carrier liquid after circulation through said bores and containing TEG compounds; at least one suction pump configured to provide negative pressure at the liquid outlet; a carrier liquid circulation subsystem to circulate said carrier liquid through said membrane bores and said liquid inlet and liquid outlet; and a carrier recycling subsystem in communication with the carrier liquid inlet and liquid outlet comprising a first evaporator and a first condenser and a mixing tank; wherein said apparatus is configured so that: exhaust gas circulates at engine pressure through said array and contacts said membranes on an exterior surface of the membranes, said carrier liquid contacts said membranes on an opposed surface thereof and said TEG thereby permeates through said membrane from the exterior membrane surface into the bore to transfer said TEG compounds from said exhaust gas into said carrier liquid to form the exit liquid; and the exit liquid is separated into a first liquid phase and a first gaseous phase by the evaporator; the first gaseous phase is separated into a second liquid phase and a second gaseous phase by the condenser; said second gaseous phase carrying the TEG; and the first liquid phase and the second liquid phase are mixed in the mixing tank to recover the carrier liquid.

In an aspect of the present invention, the system further comprises at least one of pH sensor system for determining a pH drop in said liquid carrier from circulating through said membrane array and a pressure sensor system for determining a pressure drop in said liquid carrier from circulating through said membrane array, said sensors being operatively linked to a signal processor for determining whether said pH drop and/or pressure drop is indicative of a reduced level of effectiveness of said membrane array at reducing concentrations of SO2. In another aspect of the present invention, the system further comprises a sensor for measuring SO2 concentration within untreated exhaust gas from said source and a control system in operative communication with said sensor and with a pump for controlling the flow rate of said carrier liquid through said system, said control system being configured to determine the flow rate of said carrier liquid required in order to achieve a selected level of SO2 concentration reduction and to control said pump to provide said flow rate. In another aspect of the present invention, the system further comprises a heat exchanger configured to lower the temperature of the engine exhaust gas before it enters the first of said plurality of gas treatment modules. In an aspect of the present invention, there is provided a kit comprising the inventive system and at least one carrier liquid for dissolving said TEG. In an aspect of the present invention, the carrier liquid in the kit is aqueous H3PO4+NaOH [symbol] Na2HPO4+2H2O.

In accordance with the present invention, there is provided a method for reducing the concentration of SO2 from a source of engine exhaust gas comprising the steps of: directing said engine exhaust gas from a first engine into an enclosed space containing at least one array of hollow fibre semi-permeable ceramic membranes, wherein said exhaust gas contacts an exterior surface of said membranes whereupon SO2 within said exhaust gas permeate through said membrane thereby lowering the concentration of said SO2 within said exhaust gas; circulating an aqueous NaOH carrier liquid capable of retaining said TEG through bores of said hollow fibre ceramic membranes thereby creating Na2SO3 and Na2SO4 within said carrier liquid to create an exit liquid; discharging said exhaust gas containing a reduced SO2 concentration from the enclosed space and removing said exit liquid containing said Na2SO3 and Na2SO4 therein from said hollow fibre ceramic membrane array; using an electrolyzer to convert the exit liquid into regenerated aqueous NaOH and aqueous H2SO4; and recirculating the regenerated aqueous NaOH through the bores of said hollow fibre ceramic membranes.

In an aspect of the invention, negative pressure is applied to draw the exit liquid from the hollow fibre ceramic membrane array. In another aspect of the invention, the step of using an electrolyzer to convert the exit liquid into regenerated aqueous NaOH and aqueous H2SO4 also generates hydrogen gas and oxygen gas, and the method comprises the additional step of injecting the hydrogen gas, the oxygen gas, or both the hydrogen and oxygen gas into a second engine. In another aspect of the invention, the first engine and the second engine are the same engine. In another aspect of the invention, the oxygen gas is mixed with the hydrogen gas before injection into the second engine. In another aspect of the invention, the electolyzer uses electrodialiysis. In another aspect of the invention, the electrolyzer uses electrolysis. In another aspect of the invention, the electrolyzer runs in a batch basis. In another aspect of the invention, the electrolyzer runs in a continuous basis. In another aspect of the invention, the electrolyzer runs in a batch basis. In another aspect of the invention, the amount of water in the exit liquid is adjusted by changing the temperature of the aqueous NaOH carrier liquid entering said bores.

In accordance with the present invention, there is provided a method for reducing the concentration of SO2 from a source of engine exhaust gas comprising the steps of: directing said engine exhaust gas from a first engine into an enclosed space containing at least one array of hollow fibre semi-permeable ceramic membranes, wherein said exhaust gas contacts an exterior surface of said membranes whereupon SO2 within said exhaust gas permeate through said membrane thereby lowering the concentration of said SO2 within said exhaust gas; circulating an aqueous NaOH carrier liquid capable of retaining said TEG through bores of said hollow fibre ceramic membranes thereby creating Na2SO3 and Na2SO4 within said carrier liquid to create an exit liquid; discharging said exhaust gas containing a reduced SO2 concentration from the enclosed space and removing said exit liquid containing said SO2 compounds therein from said hollow fibre ceramic membrane array; using a cooling device to cool the exit liquid to a first temperature and extract crystals of using Na2SO4 from the exit liquid creating a filtered liquid; recirculating the filtered liquid through the bores of said hollow fibre ceramic membranes; using an electrolyzer to convert the aqueous crystals of Na2SO4 into regenerated aqueous NaOH and aqueous H2SO4; and recirculating the regenerated aqueous NaOH through the bores of said hollow fibre ceramic membranes.

In an aspect of the invention, negative pressure is applied to draw the exit liquid from the hollow fibre ceramic membrane array. In another aspect of the invention, the step of using an electrolyzer to convert the exit liquid into regenerated aqueous NaOH and aqueous H2SO4 also generates hydrogen gas and oxygen gas, and the method comprises the additional step of injecting the hydrogen gas, the oxygen gas, or both the hydrogen and oxygen gas into a second engine. In an aspect of the invention, the first engine and the second engine are the same engine. In an aspect of the invention, the electolyzer uses electrodialiysis. In an aspect of the invention, the electrolyzer uses electrolysis. In an aspect of the invention, the electrolyzer runs in a batch basis. In an aspect of the invention, the electrolyzer runs in a continuous basis. In an aspect of the invention, the first temperature is between around 20 and around 45 degrees Celsius. In an aspect of the invention, the first temperature is around 35 degrees Celsius.

In accordance with the present invention, there is provided a system for lowering the concentration of SO2 from a source of engine exhaust gas comprising: an enclosure for receiving a stream of engine exhaust from a first engine; a plurality of gas treatment modules configured for installation within said enclosure, each of said modules comprising a housing and an array of hollow fibre ceramic membranes supported within the housing and configured so that said exhaust contacts the membranes as the exhaust gas is circulated through the array when the module is installed within the enclosure, each of said ceramic membranes comprising a semi-permeable membrane wall which is permeable to said SO2 and a hollow bore; a liquid inlet for feeding a carrier liquid into said membrane bores in an unsaturated state, said carrier liquid including aqueous NaOH; a liquid outlet for receiving an exit liquid from said bores, said exit liquid being the carrier liquid after circulation through said bores and containing Na2SO4; at least one suction pump configured to provide negative pressure at the liquid outlet; a carrier liquid circulation subsystem to circulate said carrier liquid through said membrane bores and said liquid inlet and liquid outlet; and a carrier recycling subsystem in communication with the carrier liquid inlet and liquid outlet comprising a first evaporator and a first condenser and a mixing tank; wherein said apparatus is configured so that: exhaust gas circulates at engine pressure through said array and contacts said membranes on an exterior surface of the membranes, said carrier liquid contacts said membranes on an opposed surface thereof and said TEG thereby permeates through said membrane from the exterior membrane surface into the bore to transfer said TEG compounds from said exhaust gas into said carrier liquid to form the exit liquid; and the exit liquid is separated into a first liquid phase and a first gaseous phase by the evaporator; the first gaseous phase is separated into a second liquid phase and a second gaseous phase by the condenser; said second gaseous phase carrying the TEG; and the first liquid phase and the second liquid phase are mixed in the mixing tank to recover the carrier liquid.

In accordance with the present invention, there is provided a method for reducing the concentration of a target emission gas (TEG) from a source of marine engine exhaust gas comprising the steps of: directing said engine exhaust gas containing TEG from the source into an enclosed space containing at least one array of hollow fibre semi-permeable ceramic membranes, wherein said exhaust gas contacts an exterior surface of said membranes whereupon TEG within said exhaust gas permeates through said membrane thereby lowering the concentration of said TEG within said exhaust gas; circulating a carrier liquid capable of retaining TEG compounds through bores of said hollow fibre ceramic membranes thereby elevating the concentration of said TEG compounds within said carrier liquid; discharging said exhaust gas containing a reduced TEG concentration from the enclosed space using a blower to reduce the gas pressure in the enclosed space and removing said carrier liquid containing said TEG compounds therein from said hollow fibre ceramic membrane array.

In one aspect of the invention, aqueous H2SO4 generated by the scrubber is used to pre-treat marine heavy fuel oil before the marine heavy fuel oil is used as a fuel in a ship's engine. In another aspect of the invention, the step of pre-treating the marine heavy fuel oil comprises the mixing the aqueous H2SO4 and marine heavy fuel oil in a mixer that is configured to facilitate soot removal. In still another aspect of the invention, the mixer is configured to remove sludge from the mixer and store the sludge in a sludge tank.

In another aspect of the invention, a method for reducing the concentration of a target emission gas (TEG) from a source of engine exhaust gas comprises the steps of: directing said engine exhaust gas from the source into an enclosed space containing at least one array of hollow fibre semi-permeable ceramic membranes, wherein an electrostatic charge is applied to said exhaust gas, and then said exhaust gas contacts an exterior surface of said membranes whereupon TEG compounds within said exhaust gas permeate through said membrane thereby lowering the concentration of said TEG within said exhaust gas; circulating a first carrier capable of retaining said TEG through bores of said hollow fibre ceramic membranes thereby elevating the concentration of TEG compounds within said first carrier; and discharging said exhaust gas containing a reduced TEG concentration from the enclosed space and removing said first carrier containing said TEG compounds therein from said hollow fibre ceramic membrane. The invention may further comprise the step of spraying a second carrier into the exhaust gas. In another embodiment the second carrier is aqueous NaOH or aqueous KOH. In another embodiment, the ceramic membranes are connected in series through the use of a manifold block and return manifold block containing recesses to connect the bores of the ceramic membranes.

In another aspect of the invention, there is provided a method for reducing the concentration of a target emission gas (TEG) from a source of engine exhaust gas comprising the steps of: directing said engine exhaust gas from the source into an enclosed space containing at least one array of hollow fibre semi-permeable ceramic membranes, wherein a pulsed corona is applied to said exhaust gas, and then said exhaust gas contacts an exterior surface of said membranes whereupon TEG compounds within said exhaust gas permeate through said membrane thereby lowering the concentration of said TEG within said exhaust gas; circulating a first carrier capable of retaining said TEG through bores of said hollow fibre ceramic membranes thereby elevating the concentration of TEG compounds within said first carrier; and discharging said exhaust gas containing a reduced TEG concentration from the enclosed space and removing said first carrier containing said TEG compounds therein from said hollow fibre ceramic membrane. The invention may further comprise the step of spraying a second carrier into the exhaust gas. In another embodiment the second carrier is aqueous NaOH or aqueous KOH. In another embodiment, the ceramic membranes are connected in series through the use of a manifold block and return manifold block containing recesses to connect the bores of the ceramic membranes.

In another aspect of the invention, there is provided a method for reducing the concentration of a target emission gas (TEG) from a source of engine exhaust gas comprising the steps of: directing said engine exhaust gas from a first engine into an enclosed space containing at least one array of hollow fibre semi-permeable ceramic membranes; spraying a first carrier into the exhaust gas; and then said exhaust gas contacts an exterior surface of said membranes whereupon said exhaust gas permeates through said membrane thereby lowering the concentration of said TEG within said exhaust gas; circulating a second carrier capable of retaining said TEG through bores of said hollow fibre ceramic membranes thereby elevating the concentration of TEG compounds within said second carrier; and discharging said exhaust gas containing a reduced TEG concentration from the enclosed space and removing said second carrier containing said TEG compounds therein from said hollow fibre ceramic membrane array. In an embodiment of this method, the first carrier is a component of the second carrier. In yet another embodiment of this method, the first carrier is the same as the second carrier.

In another aspect of this invention, there is provided a method for reducing the concentration of a target emission gas (TEG) from a source of engine exhaust gas comprising the steps of: directing said engine exhaust gas from a first engine into an enclosed space containing at least one array of hollow fibre semi-permeable ceramic membranes; spraying a first carrier into the exhaust gas; said exhaust gas contacting an exterior surface of said membranes whereupon TEG within said exhaust gas permeates through said membrane thereby lowering the concentration of said TEG within said exhaust gas; circulating a second carrier capable of retaining said TEG through bores of said hollow fibre ceramic membranes thereby elevating the concentration of TEG compounds within said second carrier; and discharging said exhaust gas containing a reduced TEG concentration from the enclosed space and removing said second carrier containing said TEG compounds therein from said hollow fibre ceramic membrane array. In one aspect of this method, the step of spraying a first carrier into the exhaust gas occurs before the exhaust gas first encounters at least one membrane array. In another aspect of this method, the step of spraying a first carrier into the exhaust gas occurs after the exhaust gas first encounters at least one membrane array.

In another aspect of the present invention, there is provided a method for reducing the concentration of a target emission gas (TEG) from a source of engine exhaust gas comprising the steps of: directing said engine exhaust gas from a first engine into an enclosed space containing at least one array of hollow fibre semi-permeable ceramic membranes; wherein said exhaust gas contacts an exterior surface of said membranes whereupon TEG within said exhaust gas permeate through said membrane thereby lowering the concentration of said TEG within said exhaust gas; circulating a carrier capable of retaining said TEG through bores of said hollow fibre ceramic membranes in series by using a block manifold with recesses and return block manifold with recesses thereby creating TEG compounds within said carrier liquid to create an exit liquid; and discharging said exhaust gas containing a reduced TEG concentration from the enclosed space and removing said exit liquid containing said TEG compounds therein from said hollow fibre ceramic membrane array. In a further aspect of this method a negative pressure is maintained across the membrane array through the use of an eductor.

In another aspect of the invention, a method is provided for reducing the concentration of a target emission gas (TEG) from a source of engine exhaust gas comprising the steps of: directing said engine exhaust gas from a first engine into an enclosed space containing at least one array of hollow fibre semi-permeable ceramic membranes; wherein said exhaust gas contacts an exterior surface of said membranes whereupon TEG within said exhaust gas permeate through said membrane thereby lowering the concentration of said TEG within said exhaust gas; circulating a carrier capable of retaining said TEG through bores of said hollow fibre ceramic membranes in series by using 180 degree elbow fittings thereby creating TEG compounds within said carrier liquid to create an exit liquid; and discharging said exhaust gas containing a reduced TEG concentration from the enclosed space and removing said exit liquid containing said TEG compounds therein from said hollow fibre ceramic membrane array. In a further aspect of this method a negative pressure is maintained across the membrane array through the use of an eductor.

In an aspect of the invention, there is provided a system for reducing the concentration of SO2 from a source of engine exhaust gas comprising: an enclosure for receiving a stream of engine exhaust; a plurality of gas treatment modules configured for installation within said enclosure, each of said modules comprising a housing and an array of hollow fibre ceramic membranes supported within the housing and configured so that said exhaust contacts the membranes as the exhaust gas is circulated through the array when the module is installed within the enclosure, each of said ceramic membranes comprising a semi-permeable membrane wall which is permeable to said SO2 and a hollow bore; a carrier inlet for feeding a carrier into said membrane bores; a carrier outlet for receiving said carrier from said bores after circulation; and a carrier liquid recycling subsystem to circulate said carrier liquid through said membrane bores and said carrier inlet and carrier outlet and further comprising an electrolyzer to regenerate the carrier; wherein said apparatus is configured so that exhaust gas circulates at engine pressure through said array and contacts said membranes on an exterior surface of the membranes, said carrier contacts said membranes on an opposed surface thereof and said SO2 thereby permeates through said membrane from the exterior membrane surface into the bore to transfer said SO2 from said exhaust gas into said carrier as SO2 compounds, and said carrier with SO2 compounds being regenerated as carrier by use of the electrolyzer.

In another aspect of the invention, there is provided a system for reducing the concentration of a target emission gas (TEG) from a source of engine exhaust gas comprising: an enclosure for receiving a stream of engine exhaust; a plurality of gas treatment modules configured for installation within said enclosure, each of said modules comprising a housing and an array of hollow fibre ceramic membranes supported within the housing and configured so that said exhaust contacts the membranes as the exhaust gas is circulated through the array when the module is installed within the enclosure, each of said ceramic membranes comprising a semi-permeable membrane wall which is permeable to said TEG and a hollow bore; a carrier inlet for feeding a carrier into said membrane bores; a carrier outlet for receiving said carrier from said bores after circulation; a carrier circulation subsystem to circulate said carrier liquid through said membrane bores and said carrier inlet and carrier outlet; and an electrostatic charge generator; wherein said apparatus is configured so that exhaust gas circulates at engine pressure through said electrostatic charge generator and then through said array and contacts said membranes on an exterior surface of the membranes, said carrier contacts said membranes on an opposed surface thereof and said TEG thereby permeates through said membrane from the exterior membrane surface into the bore to transfer said TEG from said exhaust gas into said carrier as TEG compounds.

In another aspect of the invention, there is provided a system for reducing the concentration of a target emission gas (TEG) from a source of engine exhaust gas comprising: an enclosure for receiving a stream of engine exhaust; a plurality of gas treatment modules configured for installation within said enclosure, each of said modules comprising a housing and an array of hollow fibre ceramic membranes supported within the housing and configured so that said exhaust contacts the membranes as the exhaust gas is circulated through the array when the module is installed within the enclosure, each of said ceramic membranes comprising a semi-permeable membrane wall which is permeable to said TEG and a hollow bore; a carrier inlet for feeding a carrier into said membrane bores; a carrier outlet for receiving said carrier from said bores after circulation; a carrier circulation subsystem to circulate said carrier liquid through said membrane bores and said carrier inlet and carrier outlet; and a pulsed corona generator; wherein said apparatus is configured so that exhaust gas circulates at engine pressure through said pulsed corona generator and then through said array and contacts said membranes on an exterior surface of the membranes, said carrier contacts said membranes on an opposed surface thereof and said TEG thereby permeates through said membrane from the exterior membrane surface into the bore to transfer said TEG from said exhaust gas into said carrier as TEG compounds.

### DEFINITIONS

In the present patent specification, the following terms shall have the meanings described below, unless otherwise specified or if the context clearly requires otherwise:

“Gas” or “gasses” refer to a compound or mixture of compounds that exists in the gas phase under ambient conditions of temperature and pressure.

“Diesel” refers to an internal combustion engine that of the compression-ignition design. A diesel engine can burn a variety of fuels including without limitation diesel fuel, bunker crude, biodiesel and others. The term “diesel” or “diesel emissions” is not restricted to any particular fuel type but includes any hydrocarbon fuel that may be combusted in a diesel-type engine.

“Target Emission Gas” or “TEG” refers to any gas or gasses that are intended to be removed from an exhaust gas stream generated by a combustive process. TEG's can include but not limited to Sulfur Oxides, Nitrogen Oxides, and Carbon Oxides such as CO2. It will be understood that a TEG can exist in either a gas phase or a liquid or solid phase under different conditions such as when dissolved into solution or bound to a liquid phase compound. Generally, in this document TEG is used to refer to TEGs in the exhaust gas. TEG Compound is used to indicate TEGs when absorbed, dissolved or bound into a carrier, and includes instances where the TEG undergoes a chemical reaction to create a TEG Compound in the carrier.

“Emissions” refers to total combustion exhaust gasses from an engine or other source of exhaust gasses, including target emission gas as well as other gasses.

“Carrier” refers to either one of a liquid, gas or vapour containing a compound that is capable of binding to a TEG or a liquid, gas or vapour that can dissolve a TEG into solution so as to be operative in a membrane system to selectively reduce the concentration of the TEG from a gas-rich environment.

“Semi-permeable membrane” is a membrane that allows molecules or ions to pass through it by diffusion. The rate of passage through the membrane can depends on the pressure, concentration, and temperature of the molecules or solutes on either side, as well as the permeability of the membrane to each solute. The membrane can vary in thickness, depending on the composition of the membrane and other factors. A “selectively permeable membrane”, a “partially permeable membrane” or a “differentially permeable membrane” is a membrane that allows (or more easily allows) selected molecules or ions to pass through it by diffusion.

### BRIEF DESCRIPTION OF THE DRAWINGS

In order to better understand various exemplary embodiments, reference is made to the accompanying drawings, wherein:

FIG. 1 is a schematic drawing showing an emissions reduction system according to one embodiment of the invention;

FIG. 2 is a perspective view of a gas absorption module according to the present invention.

FIG. 3 is a perspective view, exploded, of the gas absorption module of FIG. 2.

FIG. 4 is a cross-sectional view of a gas absorption module and associated housing and gas duct components.

FIG. 5 is a schematic view of internal components of the gas absorption module.

FIG. 6 is a schematic view of a hollow fiber ceramic membrane within a gas absorption module, schematically showing selective absorption of TEG's.

FIG. 7 is a schematic view a gas treatment system according to one embodiment of the invention.

FIG. 8 is a schematic view a gas treatment system according to a second embodiment of the invention.

FIG. 9 is a schematic view a gas treatment system according to a third embodiment of the invention.

FIG. 10 is a schematic view a gas treatment system according to a fourth embodiment of the invention.

FIG. 11 is a schematic view a gas treatment system according to a fifth embodiment of the invention.

FIG. 12 is a schematic view a gas treatment system according to a sixth embodiment of the invention.

FIG. 13 is a schematic view a gas treatment system according to an embodiment of the invention, showing in particular system control means.

FIG. 14 is flow chart showing operation of the control system according to one embodiment of the invention.

FIG. 15 is a graph showing the influence of water temperature on SOx absorption rate within a gas absorption module of the invention.

FIG. 16 is a graph showing the influence of water flow rate through the hollow fiber membrane array on SOx absorption rate within a gas absorption module of the invention.

FIG. 17 is a graph showing the influence of the exhaust gas flow ratio (actual flow/design flow rate) on SOx absorption rate within a gas absorption module of the invention.

FIG. 18 is a schematic view of a gas desorption vessel according to a further aspect of the invention.

FIG. 19 is a schematic view of an embodiment of the system illustrating a carrier liquid absorption and regeneration system plus an optional dehumidifier and an optional exhaust gas cooler.

FIG. 20 is a schematic view of an embodiment of the system illustrating a carrier liquid absorption and regeneration system but without an optional dehumidifier and without an optional exhaust gas cooler.

FIG. 21 is a schematic view of a specific setup for the removal of SO2 from an exhaust gas with an exhaust gas cooler (but without a dehumidifier).

FIG. 22 is a schematic view of an embodiment of the system illustrating a carrier liquid absorption and regeneration system where an NaOH or KOH carrier liquid is regenerated through an electrochemical process and hydrogen and oxygen gas are generated as a byproduct.

FIG. 23 is a schematic view of an embodiment of the system illustrating a carrier liquid absorption and regeneration system where an NaOH (or KOH) carrier liquid is regenerated by first extracting Na₂SO₄ (or K₂SO₄) from the carrier liquid and then passing the extracted Na₂SO₄ (or K₂SO₄) through an electrochemical process and hydrogen and oxygen gas are generated as a byproduct.

FIG. 24 is a schematic view of an embodiment of the system similar to that of FIG. 23 with an alternative system to process the exit carrier liquid through the elecrolyzer.

FIG. 25 is an illustration of a three compartment electromagnetic device to regenerate NaOH from NA₂SO₄ (or KOH from K₂SO₄) while also creating H₂ and O₂ gas.

FIG. 26 illustrates an optional additional embodiment where sulfuric acid generated by the electrolytic regeneration of diesel emission scrubber solution is used to pre-treat marine heavy fuel oil before it is injected into the engine.

FIG. 27 is an illustration of an embodiment where an electrostatic charge is applied to the exhaust gas.

FIG. 28 is an illustration of an embodiment where atomized NaOH or other carrier liquid is sprayed into the exhaust stream upstream of the membrane array.

FIG. 29 is an illustration of an embodiment where atomized NaOH or other carrier liquid is sprayed into the exhaust stream downstream of the membrane array.

FIG. 30 is an illustration of an embodiment where atomized NaOH or other carrier liquid is sprayed into the exhaust stream and an electrostatic charge is applied to the exhaust gas upstream of the membrane array.

FIG. 31 is a is an illustration of an embodiment where a pulsed corona is used to oxidize TEGs in the exhaust gas.

FIG. 32 is a perspective drawing of a membrane array module using a block manifold and a return block manifold.

FIG. 33 is an exploded drawing of a membrane array module using a block manifold and a return block manifold.

FIG. 34 is a cross-section of one set of ceramic membranes connected in series using a block manifold and a return block manifold.

FIG. 35 is an illustration of a return block manifold illustrating the recesses.

FIG. 36 is an illustration of a return block manifold viewed from the internal side.

FIGS. 37A and 37B are section views of the return block manifold in FIG. 36.

FIG. 38 is a perspective view of a membrane array module attached to a eductor.

FIG. 39. is a cross-section of an eductor.

FIG. 40 shows the relationship between SO2 removal efficiency and NaOH concentration for varying gas speeds.

FIG. 41 shows the relationship between carrier liquid temperature and SO₂ removal efficiency.

FIG. 42 shows the maximum gas speed to maintain 95% efficiency (350 ft/min).

FIG. 43 shows the minimum liquid flow rate to maintain 95% efficiency (5.2 GPM).

FIG. 44 shows the effect of gas temperature on absorption efficiency.

### DETAILED DESCRIPTION

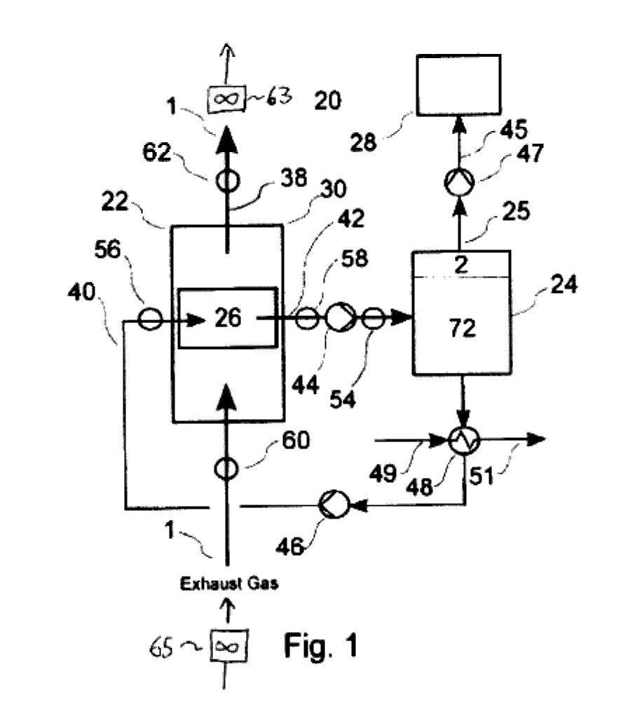

FIG. 1 is a schematic diagram of an embodiment of an exhaust gas treatment system 20 according to the invention, which is useful for reducing the concentration of one or more target emission gasses (TEG's) 2 from an exhaust gas stream 1. Gas stream 1 comprises a mixture of TEG molecules 2 and non-TEG molecules 3. The exhaust gas 1 may be generated by a marine diesel engine or other combustion process. For example, the system may be adapted to process exhaust from a heater, a burner or a gas turbine as well as various types of internal combustion engines. The gas treatment system 20 shown in FIG. 1 is a “closed loop” system that comprises in general terms a gas absorption unit 22, a TEG desorption unit 24 for separating the sequestered TEG compounds from the carrier, and associated conduits, valves, pumps and other components for circulating exhaust gas, carrier and separated TEG, as described below. In the embodiment of FIG. 1, gas treatment system 20 further comprises a gas storage module 28 which stores the isolated TEG in the form of compressed gas or other suitable storage form. As discussed below, at least some TEG's may be disposed of without storage, for example by discharging into the ocean in an aqueous solution.

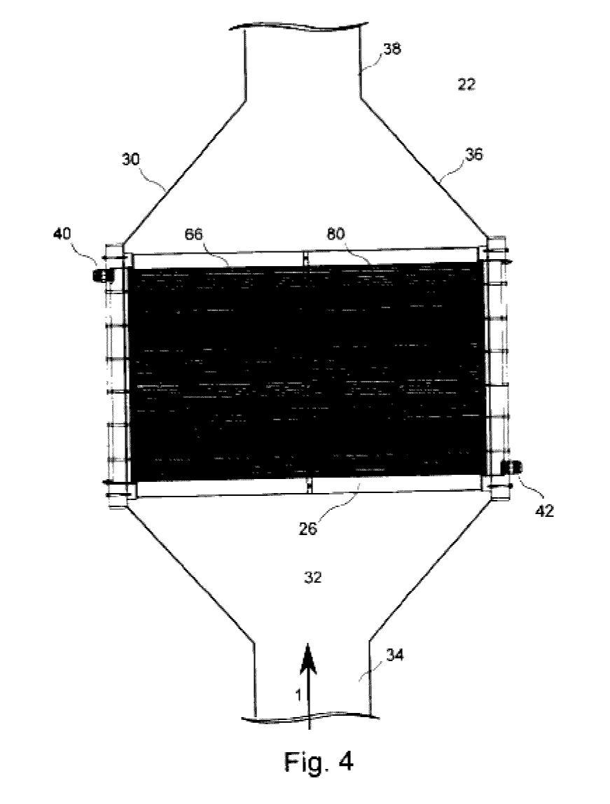

Gas absorption unit 22 comprises a main housing 30, seen in detail in FIG. 4, which houses one or more absorption modules 26. Exhaust gas is circulated through main housing 30 from gas inlet plenum 32, which receives gas from engine conduit 34. The exhaust gas is circulated through one or more absorption modules 26 that are mounted within main housing 30, following which the treated exhaust gas is exhausted through outlet plenum 36 into gas outlet conduit 38 for discharge into the environment.

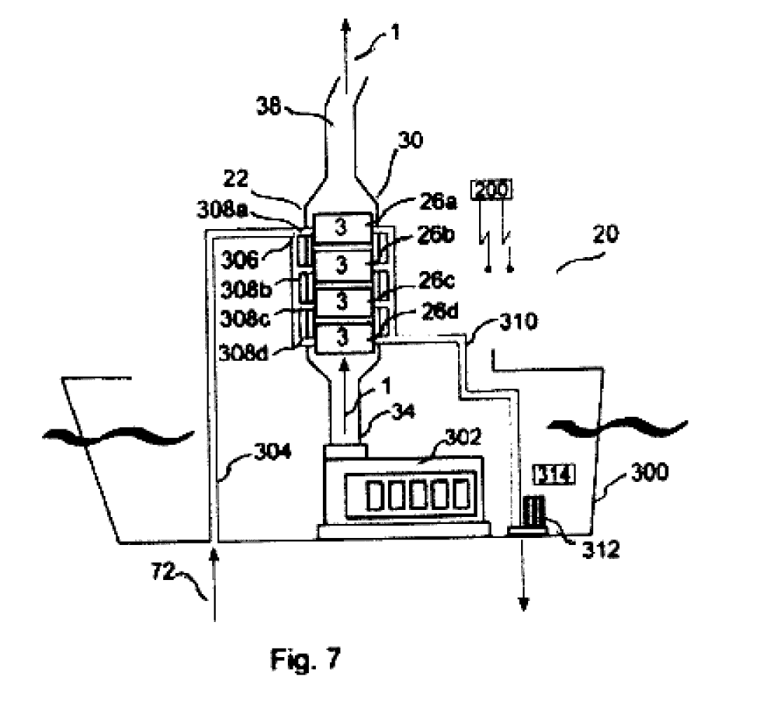

Multiple modules 26 can be configured within main housing 30 in an array for operation in parallel or in series for removing selected TEG(s) from the engine exhaust. Operation of system 20 in parallel refers to a mode of operation wherein carrier is fed to multiple modules 26 in parallel, such that each module receives equally unsaturated carrier. Operation of system 20 in series refers to a mode of operation wherein the carrier is pulled in series through multiple modules 26 whereby the liquid becomes increasingly saturated as it passes through the respective modules. FIG. 1 depicts a system containing a single module 26; FIGS. 7-12 depict alternative treatment systems in which absorption system 20 comprises multiple absorption modules 26. Each absorption module 26 contains therein a membrane assembly 66.

Exhaust gas enters gas absorption unit 22 through an inlet conduit 34 and is discharged after treatment through outlet conduit 38. Carrier is fed into gas absorption unit 22 through liquid inlet conduit 40. The carrier bearing TEG compounds exits unit 22 through outlet conduit 42 and is then fed into desorption unit 24 where the TEG is removed from the carrier. As discussed below, the carrier absorbs one or more TEG's from the exhaust gas for transport to a separate location for storage or disposal. The now-carrier without TEG compounds (or at least a lesser concentration of TEG compounds) is then recirculated into inlet conduit 40. As seen in FIG. 1, liquid flow is pressurized by a first pump 44 within outlet conduit 42. Gas outflow from desorption unit 24 is pressurized by pump or compressor 44. A heat exchanger 48 is in-line with liquid conduit 40 to remove excess heat from the recycled carrier. A coolant fluid (gas or liquid) enters heat exchanger 48 through inlet conduit 49 and exits through outlet conduit 51, for optional on-board use on the vessel.

As shown generally in FIG. 1, carrier carrying TEG compounds from separation absorption unit 22 enters desorption tank 24 wherein the carrier carrying TEG compounds is subjected to conditions of relatively reduced pressure and or increased temperature. Under these conditions, the dissolved and/or bound TEG compounds degasses and bubbles out. Dissolved mineral salts precipitate out of solution and settle to the bottom of the tank. The separated gas accumulates at the top of tank 24, from where it is released through gas outlet 25. The released gas from tank 24 flows through pipe 45 and is pressurized therein by gas pump 47, which pumps the TEG into one or more pressurized gas storage vessels 28 for safe disposal, either on-board to on shore. The carrier is then piped back into absorption unit 22 through inlet conduit 40.

Gas treatment system 20 further comprises a pH sensor 54 for measuring the pH of carrier liquid within outlet conduit 42. System 20 further comprises a first pressure sensor 56 for measuring the carrier pressure within inlet conduit 40 and a second pressure sensor 58 for measuring carrier pressure within outlet conduit 42. One or more first TEG sensors 60 are provided for detecting the level(s) of selected TEG's within the untreated exhaust entering system 20 within engine exhaust conduit 34. One or more second TEG sensors 62 are provided for detecting the levels of the selected TEG's within the treated exhaust in discharge conduit 38. The respective sensors 60 and 62 are in operative communication with a control system 200 whereby the values detected thereby are transmitted in realtime to control system 200 for efficient operation of the system, as described in more detail below.

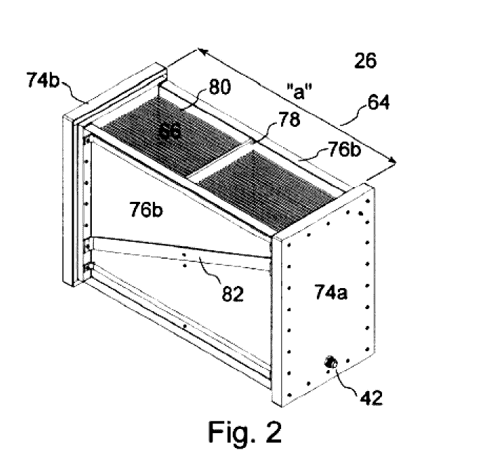

As seen in more detail in FIGS. 2-5, gas absorption module 26 comprises a housing 64 for housing a membrane assembly 66. Untreated exhaust gas 1 enters housing 64 for contact with assembly 66, following which the scrubbed gas 3 exits housing 64. The scrubbed exhaust gas is at least partially depleted of one or more TEG's 3. Within housing 64, TEG's 3 are stripped from the exhaust gas 1 by contact with a carrier inside bores through a hollow fiber semi-permeable membrane. Fresh (unsaturated) relatively cool carrier enters housing 64 through carrier inlet conduit 40 and, TEG compound-laden carrier 72 exits through outlet conduit 42.

Module housing 64 can be modular in configuration to permit convenient assembly of multiple modules 26 in the form of a single unit for installation in a vessel or elsewhere. As discussed below, multiple modules 26 can be linked in parallel or series depending on the application. Multiple modules 26 can also be dispersed throughout a ship to make best use of the available space. In one example, housing 64 is rectangular and has dimensions of 50 cm×50 cm×100 cm. Housing 64 may be fabricated from metal sheeting such as a heavy gauge stainless steel sheet. Multiple modules 26 can be secured in a rack for access and easy replacement.

Housing 64 is fabricated from sheet metal and comprises opposing side walls 74a and 74b and opposing end walls 76a and 76b. For purposes of description, an elongate axis “a” can be considered to extend between end walls 76a and b. The interior of housing 64 is divided into two essentially equal spaces by a central divider wall 78 which is parallel to end walls 76. Divider wall 78 supports hollow membrane membranes 80 within housing 64, as described below. External bracing members 82 can be provided for additional structural integrity of housing 64. Housing 64 is open above and below to allow gas to flow freely through the housing. In other embodiments, there may be more than two divider walls to support the hollow fibre membranes; in some applications there may be no need for a divider wall.

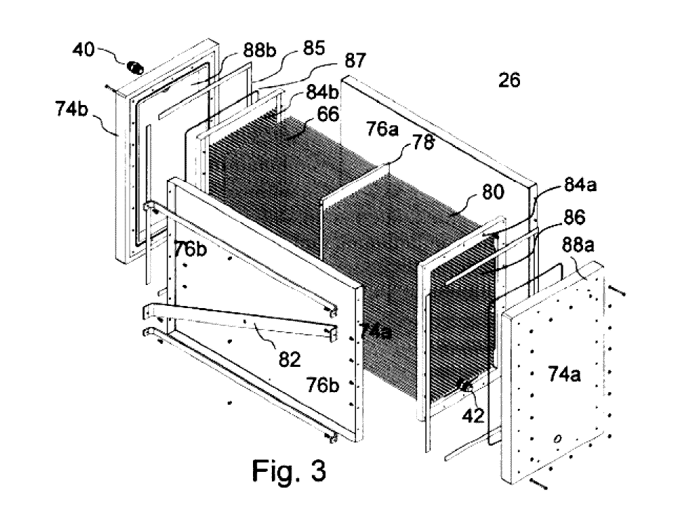

Housing 64 retains within its interior first and second perforated walls 84a and 84b (seen in FIG. 3), each having an array of perforations 86. Perforated walls 84a and b are secured to corresponding end walls 76a and b, and are of essentially identical configuration thereto to substantially cover the respective end walls 76.

End walls 76a and 76b have recessed central portions 88a and 88b respectively that open to the interior of housing 64. Recesses 88a and b are covered by respective perforated walls 84a and b, which are sealed and secured to end walls 76 by mounting strips 85 and gaskets 87. Recesses 88a and b each define an enclosed manifold, recess 88b defines an inlet manifold and recess 88a defines an outlet manifold.

Perforated walls 84 may be secured to end walls 76 by bolts or other fasteners.

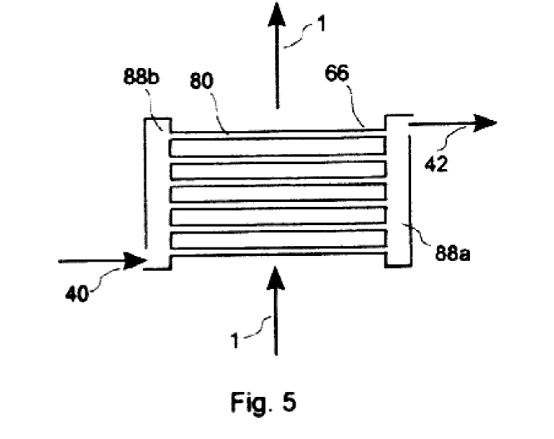

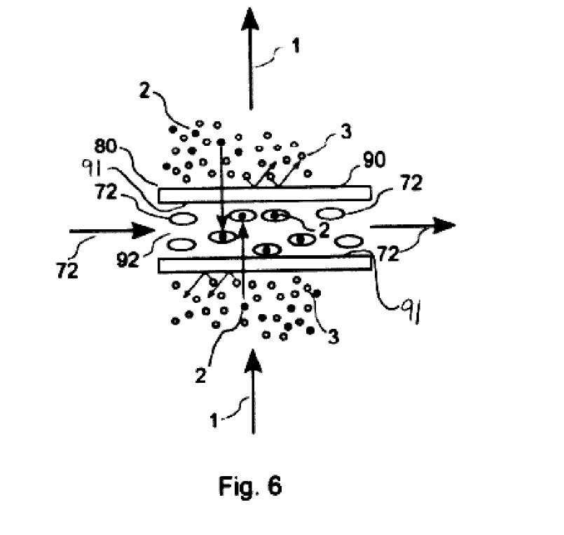

Housing 64 houses within its interior one or more membrane assemblies 66. Each assembly 66 consists of an array of porous ceramic hollow fiber membranes 80 that span the interior of housing 64, extending axially between end walls 76a and b. Membranes 80, one of which is shown in detail in FIG. 6, each comprise a tubular ceramic membrane wall 90 and a hollow central bore 92. In operation, shown schematically in FIG. 5, carrier flows through bore 92 while exhaust gas contacts the exterior of membrane wall 90. Membranes 80 are permeable in that the membrane wall has pores that permit TEG's to permeate the wall into the bore. Alternatively the membranes 80 can be semi-permeable or selective and block some or all other exhaust gasses from permeating the wall into the bore. In yet another embodiment where the scrubber is designed to remove a specific TEG, the membranes 80 are semi-permeable or selective and block some or all exhaust gasses from permeating the wall into the bore, including some TEGs that are not being specifically removed.

FIG. 4 shows an arrangement for parallel flow of carrier through the ceramic membranes. In a preferred embodiment, the membranes are connected in series (resulting in a serpentine flow through the module), and this can be arranged using 180 degree elbow bends.

The carrier circulating within bore 92 does not significantly penetrate membrane wall 90. The flow of carrier through bore 92 maintains a lower concentration (or gas partial pressure) of TEG's within the carrier, thereby generating a flow of TEG across membrane wall 90 from the gas side, where the concentration (or partial pressure) is relatively high, to the carrier side where the concentration (or partial pressure) is low. As a result, membranes 80 are able to separate TEG's from an exhaust gas stream channeled through housing 64.

The carrier circulating within bore 92 is unable to penetrate membrane wall 90 because the carrier is pulled through the porous ceramic hollow fiber membrane 80 (typically by a pump located downstream of porous ceramic hollow fiber membranes 80) rather than pushed through the porous ceramic hollow fiber membranes 80.

To maintain a high concentration gradient between the exhaust gas and carrier, the carrier should be continuously replenished along the inner surface 91 of tubular ceramic membrane wall 90 with carrier with a low concentration of TEG compounds. This system works best if the carrier is kept in a turbulent state.

Suitable ceramic hollow fiber membranes include commercially available aluminum oxide (Al2O3) hollow fibre membranes, such as the Membralox® membrane. A description of this membrane is available at: http://www.pall.com/main/food-and-beveragliqe/product.page?id=41052. Representative dimensions of a suitable membrane 80 is: pore size: 100 A; ID: 4 mm; length: 1020 mm.

Opposing ends of membranes 80 are secured within openings 86 in walls 84a and b. Membrane bore 92 communicates with a respective opening 86 at either end of membrane 80. The intersection between membrane 140 and each corresponding opening 86 is sealed against fluid (gas and or liquid) leakage. For example, membranes 80 may be secured to walls 84 at openings 86 by a soldering or gluing process. Membranes 80 pass through openings 94 within divider wall 78, which supports membranes 80 at their midpoint. It will thus be seen that fluid entering into inlet manifold 88b is distributed across membrane array 96 wherein the fluid enters into bores 92 of membranes 80. The carrier then flows through bores 92 and is discharged into outlet manifold 88a. All carrier-filled spaces within housing 64 are sealed against leakage.

The carrier enters inlet manifold 88b through liquid inlet 40 (seen in FIG. 3) from where it is distributed into membranes 80. After passing through membrane array 96, the carrier (now carrying a higher level of TEG compounds) enters outlet manifold 88a from where it is discharged through outlet too. Inlet 98 and outlet 100 are connected to hoses or other conduits, shown schematically in FIGS. 1-3, leading to other components of system 3.

Untreated exhaust gas enters housing 64 through inlet plenum 32, which discharges untreated (raw) exhaust gas from an engine or other source of contaminated gasses that contains a TEG. The gas flows through the interior of housing 64, contacting membrane array 96 as the gas travels to outlet plenum 36. Membrane array 96 essentially fills the interior of housing 64 whereby a large portion of the gas contacts at least one membrane wall 90 as the gas flows through the housing. The amount of contact between exhaust gas and the membrane surfaces will be determined by several factors including the configuration of array 96, the size and spacing of membranes 80 and the speed of gas flow through housing 64. Increased contact may be obtained by closer spacing of membranes and a larger number thereof, although this has to be balanced against a possible increase of backpressure and other factors. As a result, the configuration of membrane array 96 including the number of tubular membranes that can be included within a housing of a given size, will depend to some extent on the parameters of the engine that provides the expected source of emissions and such factors as the backpressure that can be imposed by device 3 without causing significant decrease in engine performance.

The respective gas and carrier flowpaths through the housing 64, wherein the gas and carrier streams contact opposing surfaces of membranes 80, are shown schematically in FIGS. 5 and 6. As shown, carrier 72 flows through the bore 92 or membrane 80 while the emission gas 1 contacts the exterior of membrane 80. As the raw emission gasses 1 contact the surface of membrane 80, the TEG molecules 68 within gas 1 permeate through membrane 80 from a region of high gas concentration (high gas partial pressure) to a region of low gas concentration (low gas partial pressure). Non-TEG molecules 147 concentrate within housing 64 exteriorly of membranes 80, to form a concentrated emissions gas that is rich in non-TEG components and containing a reduced amount of TEG.

The exterior of membranes 80 thus consists of a high partial pressure side of membrane wall 90, in which the concentration (or partial pressure) of TEG's within the exhaust gas is relatively high in comparison with their concentration (or partial pressure) in the carrier circulating within bore 92. The difference in concentration (or partial pressure) drives the TEG's from the exterior to the interior of membrane 80. Carrier 72 flows through the interiors of membranes 80 to maintain a consistently low concentration (or gas partial pressure) of the TEG's.

TEG molecules 68 diffuse through the membrane according to Fick's law of diffusion and exit the membrane material at the low concentration (low partial pressure) side, where they dissolve into the carrier 72 or otherwise combine with carrier 72. The stripped exhaust gas, which is rich in non-TEG molecules 3 and low in TEG molecules 68, then exits housing 64 for discharge into the atmosphere.

Carrier 72, carrying TEG compounds 68 in dissolved or bound form (depending on the carrier), then exits housing 64.

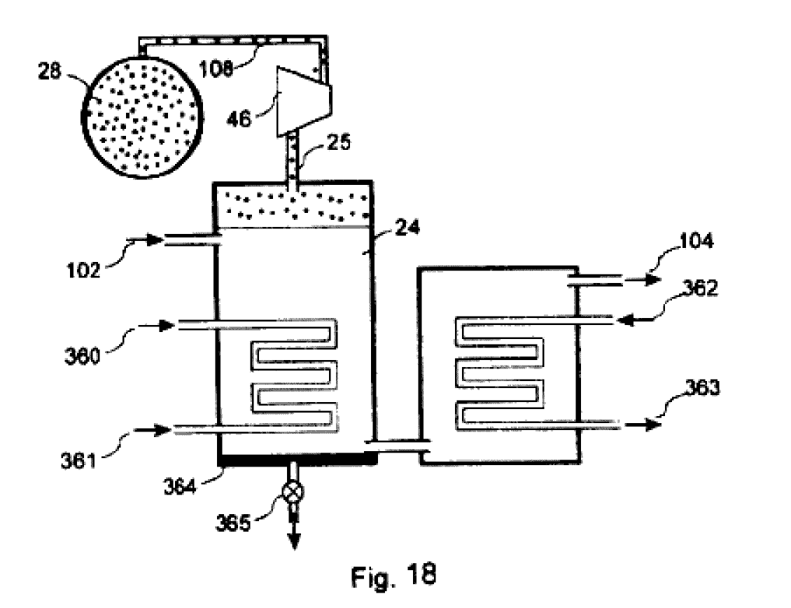

In one embodiment, carrier 72 is circulated to gas desorption vessel 24. Desorption vessel 24 is depicted schematically in FIG. 18 Vessel 24 comprises a tank for retaining the therein, and comprises an inlet 102 for gas-bearing IL, a liquid outlet 104 for the recycled (non-gas bearing) IL and a gas outlet 25 for discharge of gas separated from the ionic liquid, into gas conduit 108. The tank may comprise a tank wall of stainless steel or low carbon steel. The pressure within the tank is reduced relative to the fluid pressure within the conduits. Tank 24 is also maintained at an elevated temperature via a heat exchanger. Heating fluid enters inlet 360 and exits outlet 361. Ionic liquid enters tank 24 through inlet 102 and is allowed to degas within the tank. Within desorption vessel 24, TEG's (such as SOX, NOX, or COX) that have dissolved into the ionic liquid degas and are released from solution as bubbles under conditions of reduced pressure and/or elevated temperature relative to these conditions within absorption module 26. Optionally, an electric charge can be applied within vessel 24 to improve the efficiency of the gas separation step. The released gasses accumulate in tank 24 at an upper region above liquid inlet 102. The separated gases are released from gas outlet 25. The discharged gasses are then pressurized by compressor 46 for storage within gas storage tank 28. The compressed gasses may then be safely disposed of on land. The IL is cooled via heat exchanger prior to discharge from outlet 104 and re-use. Coolant fluid enters inlet 362 and exits outlet 363. Precipitation of salts and insoluble compounds within Tank 24 settle in the bottom and can be periodically purged via valve 365.

Generally, carrier 72 may comprise a task specific ionic liquid (TSIL) which binds with the TEGs molecules and increases diffusion efficiency through the phenomenon commonly referred to as the facilitated transport.

Examples of TSILs that may be used in the present invention, either alone or in combination, include:
1,1,3,3-tetramethylguanidium lactate [TMG][L]
Monoethanolammonium lactate [MELA][L]
i-Butyl-3-methylimidazolium tetrafluoroborate [BMIm][BF₄]
i-Butyl-3-methylimidazolium methylsulfate [BMIm][MeSO₄]
i-Hexyl-3-methylimidazolium methylsulfate [HMIm][MeSO₄]
i-Ethyl-3-methylimidazolium methylsulfate [EMIm][MeSO₄]
i-Butyl-3-methylimidazolium hexafluorophosphate [BMIm][PF6]
i-Butyl-3-methylimidazolium trifluoromethanesulfonate [BMIM]OTf.
i-butyl-3-methyl-imidazolium hexafluorophosphate ([C4mim][PF₆])

Alternatively, carrier 150 may comprise sodium hydroxide (typically aqueous sodium hydroxide, although sodium hydroxide can be dissolved in other mediums), which can be used to absorb sulfur oxides from the emission stream and neutralize sulfur acids.

Treatment system 20 is normally able to operate at engine pressure—the unadjusted pressure at which exhaust enters the scrubbing apparatus (which may include the effects on pressure of equipment such as an economizer through which the exhaust gas passes while travelling from the engine to the scrubbing system).

In some cases, system 20 can generate excessive back pressure, depending on the engine design or manufacturer-imposed requirements and the number of other systems that contribute to back pressure such as turbo units, heat exchangers, pipe bends etc. If the back pressure exceeds a predetermined maximum, turning to FIG. 1 a booster fan 63 can be provided to boost the exhaust pressure downstream of system 20 to reduce back pressure imposed by system 20. Booster fan 63 can also be useful if the engine exhaust gas must be drawn from an engine at a distance. If desired, for example to draw exhaust gases from an engine at a distance, turning to FIG. 1 a booster fan 65 can additionally or alternatively be provided to boost the exhaust pressure upstream of system 20.

FIGS. 7-12 depict alternative embodiments of gas treatment system 20.

One embodiment of system 20, seen in FIG. 7, is an “open” system installed in a marine vessel 300. In this embodiment, carrier liquid 72 comprises water such as sea water or fresh water pumped from the surrounding water environment of the vessel and then discharged back into the water after one or more TEG compounds have dissolved into the water. Water (in particular seawater) can absorb sulfur oxides from the emission stream and neutralize sulfur acids. Gasses generated by marine diesel engine 302 are discharged into exhaust conduit 34. Within desorption unit 22 are installed multiple (in this case four) gas absorption modules 26a-d, which are linearly arranged in series within housing 30. Exhaust gas passes through housing 30, contacting respective membrane assemblies 66 within modules 26a-d and is discharged to the atmosphere through discharge conduit 38.

In the embodiment of FIG. 7, seawater (or freshwater, if the vessel is traveling in a freshwater environment) is drawn from the surrounding water through inlet pipe 304, which opens at one end to the exterior of vessel 300. Pipe 304 enters a pipe splitter 306 wherein the water flow is diverted through 4 individual pipes 308 a-d, which in turn each feed into a corresponding inlet manifolds of respective absorption modules 26a, 26b, 26c and 26d. Modules 26a-d operate in parallel with respect to carrier circulation wherein the carrier is fed through the respective modules in parallel. The sea or fresh water circulates through the respective modules where it becomes infused with TEG compounds dissolved therein from the exhaust passing through the respective modules. The water containing TEG compounds is then collected into a common discharge conduit 310 and is discharged back into the ocean or lake. Water is pumped through the system by a pump 312 at the outlet end of the water circulation system. Pump 312 is controlled by pump controller 314, as discussed below.

The multiple modules can be the same or different. In the case of different modules, the membrane assemblies therein can be configured with different pore sizes and/or membrane wall thicknesses to absorb different TEG's.

Furthermore, although FIG. 7 depicts four modules 26a-d, any number of modules may be provided depending on the flow rate of exhaust gas, desired TEG reduction level and other parameters.

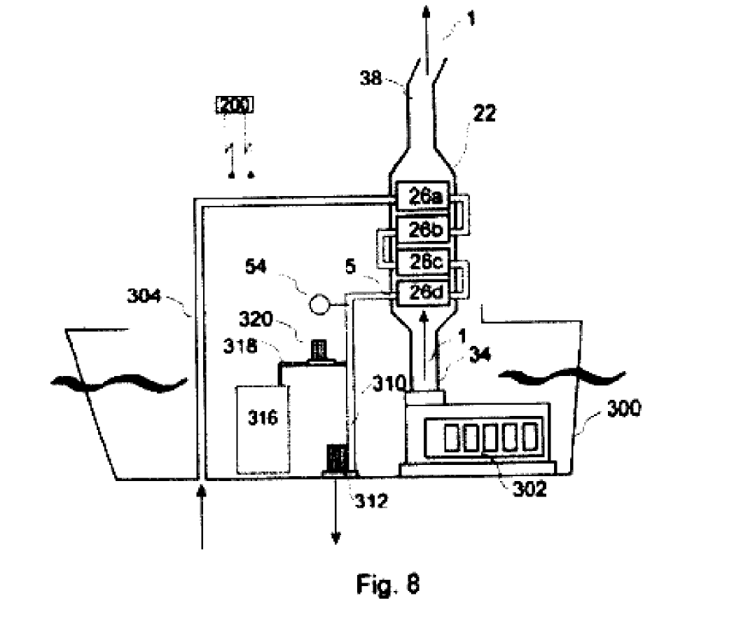

An embodiment depicted in FIG. 8 is an “open” system similar to FIG. 7. However, rather than a parallel delivery of carrier to modules 26a-d, in the example of FIG. 8, carrier (sea/freshwater) is delivered to modules 26a-d in series, i.e. sequentially. Thus, water inlet conduit 304 initially delivers water to module 26a, from where it is discharged into module 26b and so forth until finally discharged from module 26d, back into the surrounding seawater. FIG. 8 depicts an optional component that dispenses a neutralizing compound such as MgOH which can be selectively introduced into the saturated seawater prior to discharge into the ocean to reduce the acidity of the discharged water in order to comply with any applicable regulatory restrictions against discharge of acid solutions. A basic solution is stored in a tank 316 and discharged through a pipe 318 into water conduit 310. The basic solution is pumped by a pump 320 which is controlled by controller 200 responsive to the pH level of the water exiting the modules and containing TEG Compounds, as detected by pH sensor 54. The basic solution is combined with the carrier liquid carrying TEG Compounds at a rate selected to reduce the acidity therein by a selected level, for example for regulatory compliance.

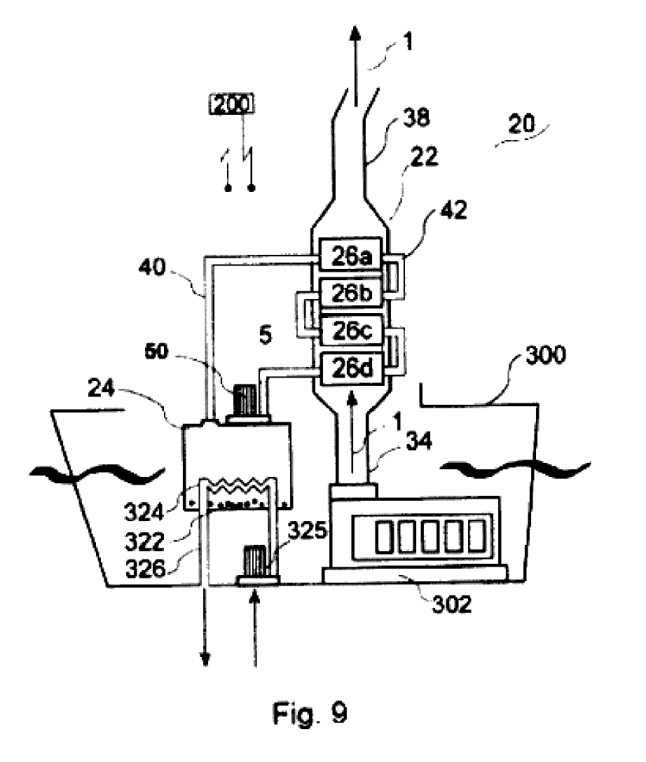

FIG. 9 depicts a “closed loop” version of system 20 wherein the carrier liquid 72 consists of a fifty percent (50%) V:V NaOH:water solution which is cycled through system 20. In this embodiment, engine exhaust is channeled through gas absorption unit 22 which in this example comprises four TEG absorption modules 26a-d. Carrier liquid from desorption vessel 24 is pulled through inlet pipe 40 and into absorption unit 22 by variable speed pump 44 and circulated sequentially through modules 26a-d. Pump 44 is in turn controlled by a pump controller in operative communication with controller 200. Within absorption unit 22, the heat from the engine exhaust 1 elevates the temperature of the carrier liquid and causes it to absorb TEG 68 such as sulfur oxides, which dissolve into solution within carrier liquid 72. The acidic sulfur oxide molecules are neutralized within the sodium hydroxide carrier solution. Within desorption vessel 24, the carrier liquid 72 is cooled, which causes the dissolved TEG's to precipitate out as solid precipitates 322. If the TEG comprises sulfur oxides, the precipitates comprise sulfides. The precipitates 322 accumulate in the bottom of vessel 24 and can be removed periodically for on-shore disposal. The cooling of carrier liquid 72 within desorption vessel 24 may be performed by a heat exchanger 324. Water from the surrounding environment is circulated through heat exchanger 324 by pump 325, through water pipes 326. Pump 325 is controlled by pump controller which is in operative communication with controller 200.

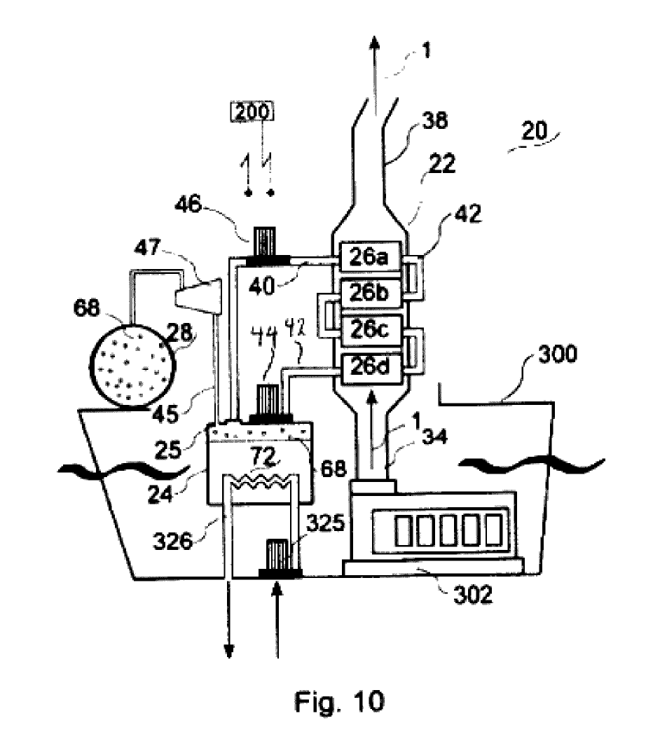

FIG. 10 depicts an embodiment of system 20 wherein the carrier 72 is an ionic liquid and enters absorption unit 22 through inlet conduit 40. The carrier flows in sequence through multiple absorption modules 26a-d. The carrier bearing a relatively high concentration of TEG compounds then flows through discharge conduit 42 where it is pressurized by pump 44 and enters into desorption vessel 24. Within desorption vessel 24, the carrier liquid is subjected to conditions whereby the absorbed TEG compounds degas from carrier liquid 72 and form TEGs 68, for example by reducing the pressure within vessel 24. The separated TEG 68 are released in a gas phase through opening 25 of vessel 24 into conduit 45. The TEG gasses are pressurized by compressor 47 into storage vessel 28. The carrier is then pumped back into absorption unit 22 through inlet conduit 40. A pump 46 on the inlet conduit 40 is useful but not required to pump carrier liquid 72 out of depressurized desorption vessel 24, particularly if the carrier liquid 72 needs to be pumped to a height. The pumps 46 and 44 must be coordinated so that there is negative pressure across the absorption modules 26a-d—i.e. that the pressure of carrier 72 upon entry into the absorption modules 26a-d is greater than the pressure of carrier 72 upon exit from the absorption modules 26a-d. The embodiment of FIG. 10 is configured to operate in a “zero discharge” mode, wherein the circulating carrier liquid is an ionic liquid.

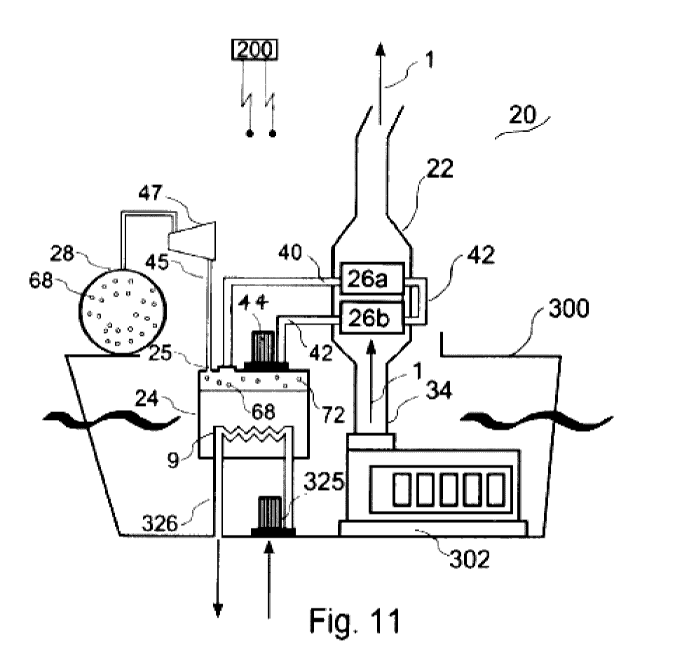

FIG. 11 depicts an embodiment similar to FIG. 10, with two absorption modules 26a and 26b and no pump 46 on the inlet conduit 40. The carrier attracts TEG compounds within modules 26a and 26b. The carrier bearing a relatively high concentration of TEG compounds is piped via conduit 42 into desorption vessel 24 where it is de-gassed by means of de-pressurizing the carrier. The carrier is recirculated through modules 26a and 26b via conduit 40. In this embodiment, a single pump 44 is provided on conduit 42 to circulate the carrier liquid through the system and degassing of the saturated carrier liquid is performed solely by depressurizing liquid within vessel 24. Pump 44 must be exerting sufficient pressure to pull carrier 72 out of desorption vessel 24 and through inlet conduit 40 into and through absorption modules 26a-d.

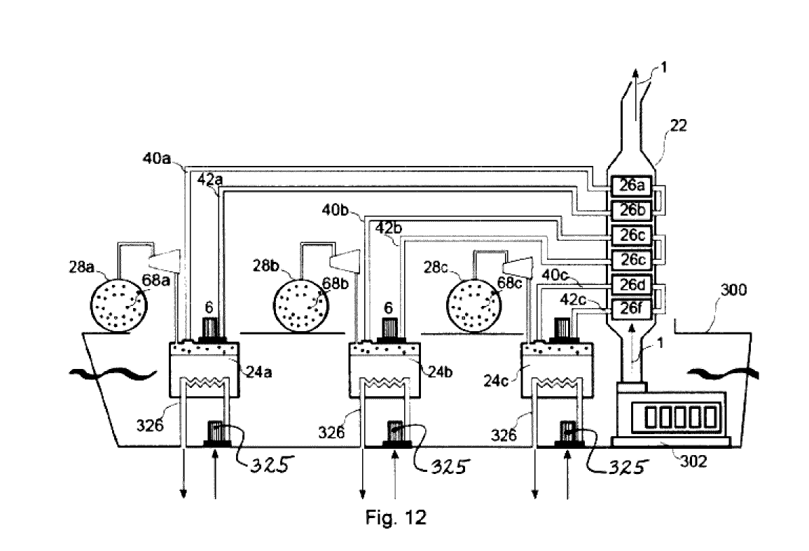

FIG. 12 depicts an embodiment of system 20 configured to independently separate and store multiple selected TEG's in a zero discharge mode wherein the selected TEG's are independently removed and stored. In this embodiment, absorption unit comprises 6 absorption modules, 26a-f. The modules are arranged in three pairs, 26a and 26b being a first pair, 26c and 26d being a second pair, and so forth. Each pair of modules is configured to channel carrier in series through the respective modules of the pair. Different carriers which are ionic liquids are circulated through the respective pairs of modules in independent circuits to individually separate selected TEG's. A first closed carrier loop comprises a first carrier inlet 40a which circulates carrier through modules 26a and 26b. The carrier bearing a relatively high concentration of TEG compounds from the first loop is then discharged into discharge conduit 42a into first desorption vessel 24a. Within vessel 24a, a first TEG 68a is separated from the carrier and is pressurized into first gas storage vessel 28a. A second closed loop comprises conduits 40b and 42b, which circulate carrier through a second pair of modules 26 c and d and a second desorption vessel 24b. A second gas storage vessel 28b is provided to store a second TEG 68b. A third closed loop is similar in configuration for separating and storing a third TEG 68c. Carrier 72 flows back to modules 26a-f through pipes 42a-c to complete the three independent fluid circuits. The respective carriers may comprise three different ionic liquids, selected to absorb specific TEG's. For example, the carriers may comprise: 1) i-Butyl-3-methylimidazolium methylsulfate [BMIm][MeSO4] for absorbing SOx, 2) i-butyl-3-methyl-imidazolium hexafluorophosphate ([C4mim][PF6]) for absorbing CO₂, and 3) i-Butyl-3-methylimidazolium trifluoromethanesulfonate [BMIM]OTf for absorbing NOx. As illustrated, pumps 44a-c exert sufficient pressure to pull carrier out of desorption vessels 24a-c and through inlet conduits 40a-c into and through absorption modules 26a-f. If necessary or desired, additional pumps may be added to inlet conduits 40a-c to pull carrier out of desorption vessels 24a-c in a manner similar to pump 46 in FIG. 10.

A further alternative embodiment of a TEG desorption system is shown in FIG. 18. In this embodiment, an ionic liquid carrier with a relatively high concentration of TEG compounds enters a desorption chamber 24 through inlet conduit 102 which outlets into vessel 24 at an upper portion thereof. A pressure drop on entering chamber 24 causes the carrier to degas to release the TEG's. The gas-phase TEG's are then discharged through conduit 25 and are pumped by compressor 46 through conduit 108 into storage vessel 28. The carrier within chamber 24 is cooled by circulating a coolant fluid through a sealed pipe within chamber 25. The coolant fluid enters via pipe 360 and is discharged by pipe 361. Carrier exits chamber 24 adjacent its base, and enters into a secondary vessel 367. The carrier is further cooled within the secondary vessel by additional coolant fluid which is circulated through a sealed pipe within the interior of the secondary vessel. The additional coolant enters via pipe 362 and exits via pipe 363. The cooled carrier then exits the secondary vessel through discharge conduit 104, for circulation within one or more gas absorption modules 26, not shown.

The carrier used in the “zero discharge mode” embodiments, including but not limited to those in FIGS. 9-12 and 18, may be a Task Specific Ionic Liquid “TSIL”. The TSIL comprises a reversible carrier. This permits the TEG compound+TSIL solution 7 (IL with TEG dissolved therein) to be separated in the desorption vessels 24 (a-c) by the application of differential pressure, temperature and/or or electric potential.

The desorption vessel 24 may be operated at near zero pressure to improve the dissociation rate of the TEG compounds and TSILs. An electric potential may also be applied to improve the dissociation of the TEG compounds and TSILs.

The TEGs are freed as a gas within the desorption vessels 24 a-c, and collected and stored in pressurized vessels 28a-c, or combined as a compound for storage as a solid. The TSILs remains as a liquid within the desorption vessels 24a-c. The TSIL is then pumped back to the gas absorption unit 22.
A supplemental amount of TSIL may be added periodically from a storage vessel to replace any TSIL lost through evaporation or chemical decomposition.

In one embodiment, heat from the engine exhaust is extracted with a heat exchanger prior to entering housing 64. This provides two benefits. The first is that lower temperatures may result in a more efficient reduction in TEGs in the exhaust, as discussed below. The second benefit is to apply the captured heat energy to provide the differential temperature to dissociate the TEG compounds and TSILs. The overall thermal efficiency of the system is improved, reducing the energy to operate the system.

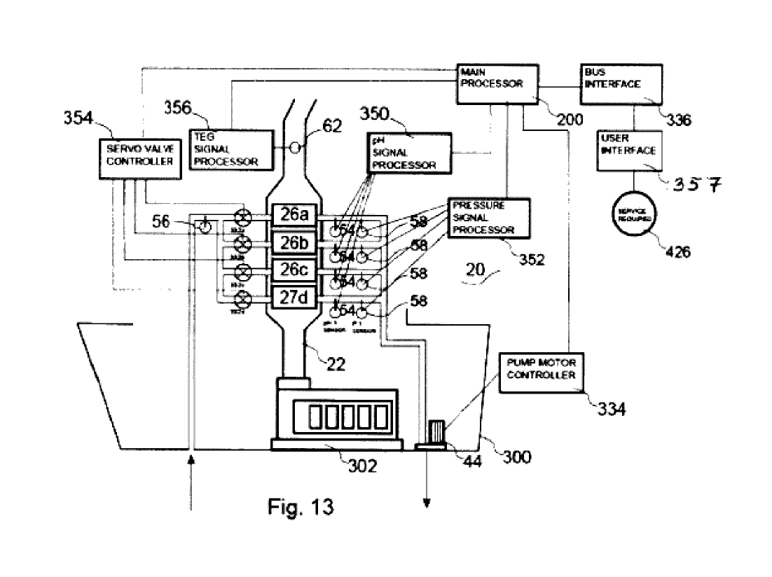

As shown schematically in FIG. 13, absorption system 20 comprises monitors and detectors, described below, that monitor selected system operating parameters and transmit the resulting data to controller 200 during operation of the system. These include: an upstream liquid pressure detector 56 which measures carrier pressure prior to entry into membrane modules 26; multiple downstream liquid pressure detectors 58, which measure carrier pressures downstream of each membrane assembly, wherein the detected difference between pressures represents a pressure drop occurring largely within a respective membrane module 26; and multiple pH sensors 54 located downstream of respective membrane module 26 for measuring the pH of carrier exiting each membrane module 26. Optionally, a pH sensor can be provided upstream of membrane modules 26 to detect the pH level of the carrier liquid prior to flowing through the membrane modules 26, thereby allowing a determination of the pH difference.

The control system 200 for operation of gas treatment system 20 is described below. The operation of system 20 is configured to optimize the mass transfer or absorption exhaust gas to ensure that the exhaust gas sufficiently contacts the membrane exterior surface to permit it to be absorbed through the membrane, utilizing principles of mass transfer. Control system 200 comprises in general terms a computer processor that includes a random access memory (RAM), a data storage module such as a hard drive and a user interface 330 comprising display and a data entry terminal. Control system 200 is in operative communication via wireless or wired data communication links with the sensors and detectors described herein and the various controllable components described herein including the adjustable valves, pumps, compressors and other adjustable components described herein that permit operation of gas treatment system 20.

As seen in FIG. 13, multiple pH sensors 54 and pressure sensors 58 are provided within respective carrier discharge conduits 42. pH sensor 54 transmits data to pH signal processor 350 and pressure sensor 58 transmits data to pressure signal processor 352. The respective signal processors can comprise independent units in communication with controller 200 or incorporated therein. Carrier liquid valves 332a-d are provided within respective carrier inlet conduits 40 to control carrier flow into respective absorption modules 26 a-d. Valves 332a-d are independently controlled by a servomotor value controller 354. A TEG level sensor 62 is provided within exhaust discharge conduit 38 to detect the level(s) of selected TEG's. A TEG signal processor 356 is responsive to signals generated by TEG level sensors 62. A pump motor controller 334 is associated with water pump 44 to control operation of pump 44. The above detectors, sensors, and controllers are operationally linked to the main processor of control system 200, which in turn is operationally linked to a user interface 357 via a system bus 336.

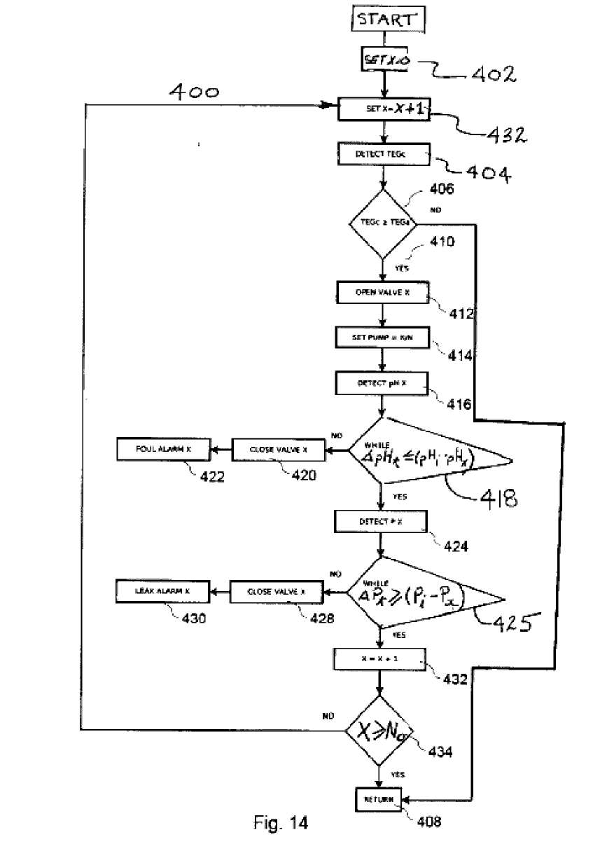

FIG. 14 is a flowchart showing operation of control system 200. In this figure:

TEGc=Target Emission Gas Concentration as measured with sensor 62 at the funnel (exhaust outlet) after passing through the absorption unit 22.

TEGa=Target Emission Gas allowable limit, for example 25 ppm for SOX.

X=index for the counter, which tracks the numbers of gas absorption modules 26 that are in operation and operative.

N=total number of modules 26 available for use in system 20, for example N=20 modules for 8 MW engine.

N₀=total number of operational modules.

Control system 200 initializes operation of the system and monitors the performance of absorption modules 20 according to the following steps:

1. At step 400, power-on control system 200 from standby mode. This step may be taken either before or after the vessel engine is powered on.

2. At step 402, enter into control system 200 form the user interface the total number of gas absorption modules 26 available in the system. This step may be pre-programmed into the control system. If not previously performed, the normal operating pressure of modules 26 may also be entered.

3. At step 404, measure the TEGc with gas sensor 62 and compare this value to the TEGa at step 406. Step 406 further comprises a determination of the number of modules of system 20 that should be actuated for system 20 to operate at an optimal efficiency level. For example, the system may contain 20 modules, and control system 200 may determine that only 15 modules are required to provide the target TEG reduction.

4. If the untreated engine exhaust contains a low level of TEG's below a selected value (TEGc is less than TEGa), the system will not turn on and the system returns to standby mode at step 408. If the TEGc levels exceed the TECa value, the system is put into operation at 410.

5. If the system is put into operation, liquid flow valve 332a for a first module 26a is actuated at 412 and the liquid pump 44 is actuated at step 414 to run at 1/N speed. This provides variable speed control. For example, if the system contains 20 modules, and control system 200 determines that only 15 modules are required to provide the target TEG reduction, then pump 44 is run at 15/20 of full operational speed, thereby reducing the power requirements for operating the system. The system then performs tests on the selected number of modules according to the steps described below. Pumps 312 are controlled by pump controller 314 which is a unit that is either responsive to controller 200 or incorporated therein.

6. The pH of the liquid solution is measured at the exit of the first absorption module 26a by pH sensor 54 at step 416. This value is indicated as pHx in FIG. 14. This pH level is compared to input pH (pHᵢ) at step 418. When acidic gases such as SOX, NOX, COX are extracted into the carrier, this acidifies the carrier circulating through the membranes. The level of acidification is used to determine whether the membrane assembly has become fouled and incapable of absorbing TEG's wherein a pH drop that exceeds a target level (ΔpHₜ) is indicative of fully functional membranes and a pH drop that fails to exceed this level is indicative of a membrane assembly that has become fouled. This can avoid the need to visually inspect the membranes. If the pH difference is less than 0.1 across a module, this is indicative that acidic gases are not being absorbed by the modules 26 and the membranes therein are fouled. For reference, seawater pH is typically limited to a range between 7.5 and 8.4.

7. If pH X fails to reach pHt, indicative of fouling of membrane module 26a, then valve 332a is turned off at step 420, shutting off the unit, and the SERVICE REQUIRED indicator 426 is actuated at step 422. This sends a signal to service the affected module. Optionally, the signal may be sent to both an on-board monitor and also a wirelessly transmitted signal to an on-shore operator who can then arrange for a replacement module at the next port of call of the vessel. If the pH detected at step 416 remains less than pHt, then the system proceeds to step 424.

If a module is shut off for service per the above, then the system must activate a new module, such that X in FIG. 14 remains the same.

8. At step 424, carrier pressure is measured via 58 at the membrane outlet side (Px) within carrier discharge conduit. At step 425, this pressure is compared with the input pressure Pᵢ detected by pressure sensor 56 to determine a pressure drop. A pressure drop that exceeds a predetermined level (pressure tolerance level, ΔPt) is indicative of a leak, for example caused by a broken tube or seal.

9. If there is a leak, or broken tube, the control system will close the valve at step 428 and sound an alarm at step 430. This sends a signal to service the affected module. Optionally, the signal may be sent to both an on-board monitor and as a satellite signal to the next port of call to schedule service to the system.

10. If no excessive pressure drop is detected, the above steps are repeated for subsequent operational modules 26b, c etc. (X=X+i) at steps 432 and 434 to determine whether any of these modules are fouled or leaking. Once the above steps have been performed for the optimal number of modules required for operation at the target efficiency, as determined at step 406, controller 200 continues to run the system, as shown at step 408, with this number of modules and at the corresponding pump speed for optimum efficiency.

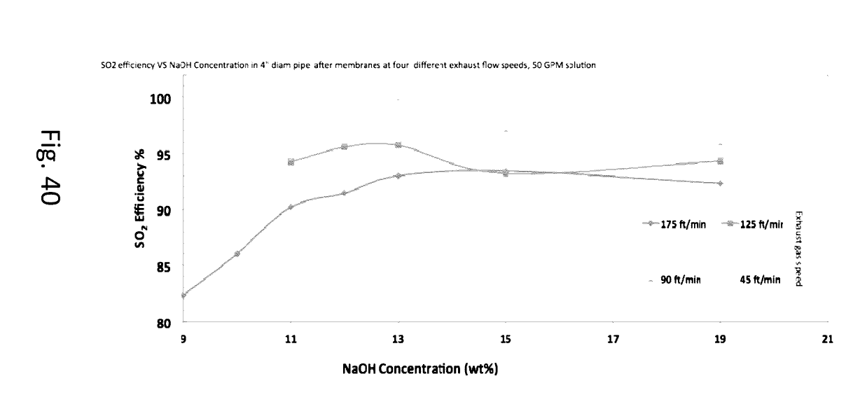

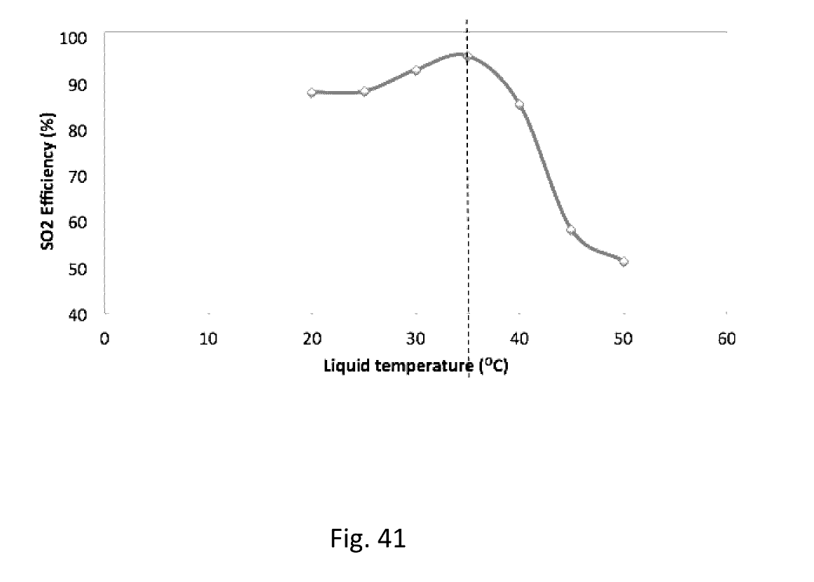

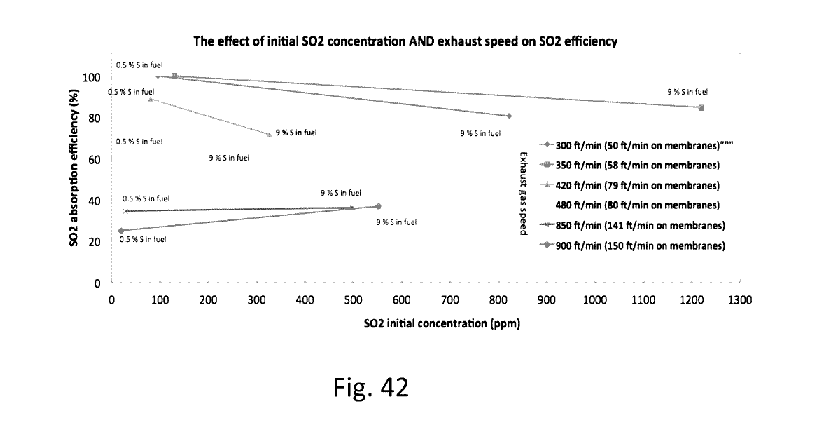

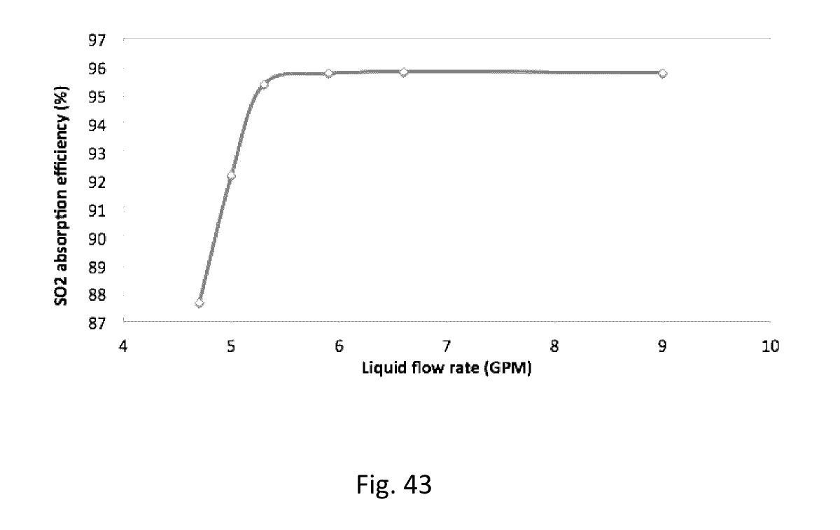

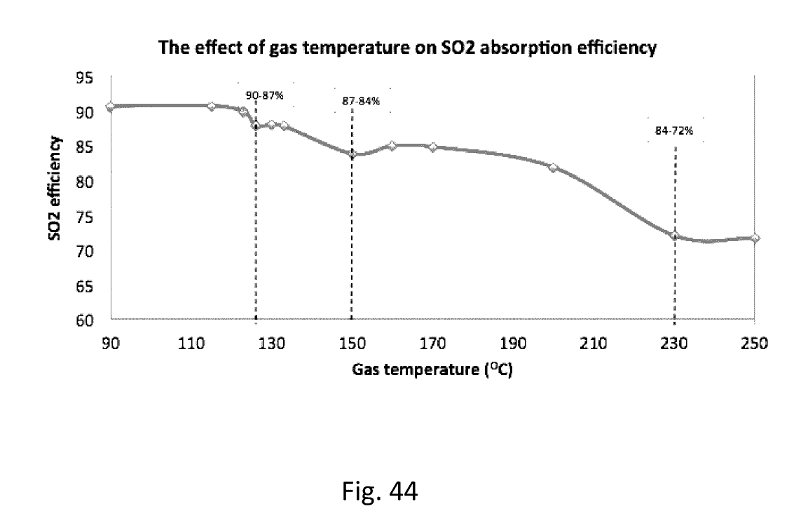

Tests have been performed to show operational results obtained with the present system using a water carrier. The results of such tests are summarized in the graphs shown in FIGS. 40-44.

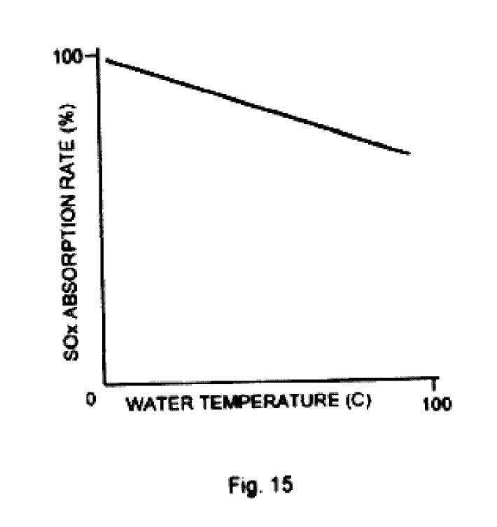

FIG. 15 shows the effect of water carrier temperature on absorption rate of SOX. A lower water temperature increases absorption rate.

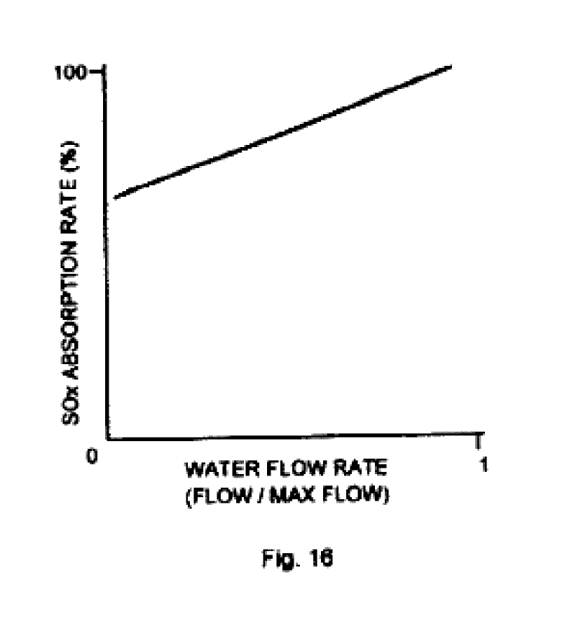

FIG. 16 shows the effect of water (carrier) flow rate on the absorption rate of SOX. A faster flow rate increases absorption rate.

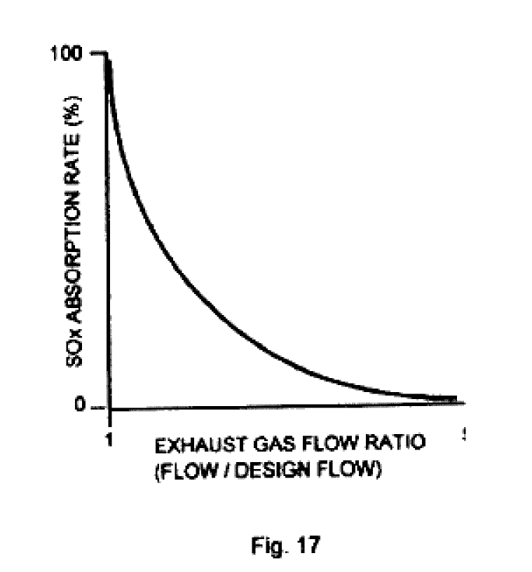

FIG. 17 shows the relationship between exhaust gas flow and absorption rate of SOX. The efficiency drops as the flow rate increases above the predetermined “design” flow rate.

When running the apparatus as discussed above, there may be wicking of the carrier to the outside of the ceramic membranes. This is undesirable, as it decreases the efficiency of the removal of the TEG's from the exhaust gas, and the wicking carrier may (if a liquid) drip and form puddles underneath the ceramic membranes. The wicking carrier may also be corrosive, damaging the scrubber equipment.

This wicking may be ameliorated through the application of negative pressure on the outlet side of the ceramic membranes, typically through the use of a suction pump. (Negative pressure is when the pressure at the inlet of a membrane(s) is higher than the pressure at the outlet of the membrane(s)) Such suction pumps are illustrated as pump 312 in FIG. 7 and pump 50 in FIG. 9. This will mimic the effect of making the ceramic membranes hydrophobic, with the result that the TEG's will more easily penetrate the ceramic membrane, increasing the efficiency of the transfer of the TEG's into the carrier.

It is believed that the wicking effect may be ameliorated with low levels of negative pressure. In practice, the inventive apparatus has been run with a liquid carrier and negative pressures ranging from −25 PSI to −7 PSI, with elimination of the wicking problem observed.

In theory, the ceramic membranes may be primed through the application of a powerful enough suction pump. In practice, it has been found to be useful to use one or more priming pumps to fill the ceramic membranes. Such priming pumps are illustrated as pump 46 in FIG. 10. Once the ceramic membranes are filled, the suction pump (44 in FIG. 10) is turned on, and the priming pump may be turned off.

Similarly, the negative pressure may be created by one or more suction pumps located at the outlet of the ceramic membrane(s). In one preferred embodiment, the ceramic membranes are primed through the use of one priming pump, and there is a suction pump for each module. For reliability, it is preferable to have more than one suction pump. If one suction pump fails, the other suction pumps can compensate.

In operation, humidity in the exhaust stream may result in condensation on the ceramic membranes and more generally within the scrubber modules. This is undesirable as this will reduce the efficiency of the ceramic membranes for TEG's transfer. This may also result in the creation of sulphuric acid or the pooling of water and/or sulphuric acid in the scrubber modules, and lead to heavier maintenance requirements.

To address this concern, a molecular sieve (or other device to remove moisture from a gas) may be used to dehumidify the exhaust gas before it enters the scrubber modules or encounters the ceramic membranes. For example, an Enviro-Tronics™ molecular sieve BLD 4123/01-03 can be used for this purpose; however a much larger capacity molecular sieve would have to be used in a commercial application on a ship. An example of the latter is a SupasivNanomol™ from Ashton Industrial.

As discussed above, specific carrier liquids called Task-Specific Ionic Liquids or TSIL's may be selected for superior performance in extracting specific TEGs from the exhaust gas of a marine engine. A ship necessarily is a closed system in respect of carrier liquids (apart from open-loop implementations where the carrier is sea water). Use of a non-resuable and non-regenerative carrier liquid requires the ship to carry enough carrier liquid to last throughout the entire voyage, and to have sufficient capacity to store the carrier liquid before use and the carrier liquid after use. The need to carry the weight of carrier liquid as well as the space requirements to store the carrier liquid both before and after use is very costly to the shipping company. Use of a regenerative carrier liquid addresses both of these concerns, by reducing the weight of carrier liquid onboard and reducing the space requirements for storing the carrier liquid, allowing the ship to carry more revenue-generating cargo.

An example of a regenerative TSIL is the use of a phosphoric acid regeneration system to remove SO₂. The beginning or clean carrier liquid H₃PO₄+NaOH will inter react to create Na₂HPO₄+2H₂O (in the aqueous phase), i.e.:

H₃PO₄+NaOH [symbol] Na₂HPO₄+2H₂O (I)

When the mixture of H₃PO₄, NaOH, Na₂HPO₄ and 2H₂O encounters SO₂ in the ceramic membrane, new aqueous products are formed:

Na₂HPO₄+SO₂+H₂O [symbol] NaSO₃+NaH₂PO₄ (II)

The SO₂ may be recovered from the liquid carrier by using two heat exchangers. The first heats the SO₂-bearing carrier liquid to separate gaseous H₂O and SO₂ from a liquid NA₂HPO₄. The second heat exchanger condenses the H₂O, leaving gaseous SO₂ of a high purity. The Na₂HPO₄ and H₂O are mixed, thus recreating the original carrier liquid.

H₃PO₄+NaOH [symbol] Na₂HPO₄+2H₂O (I)

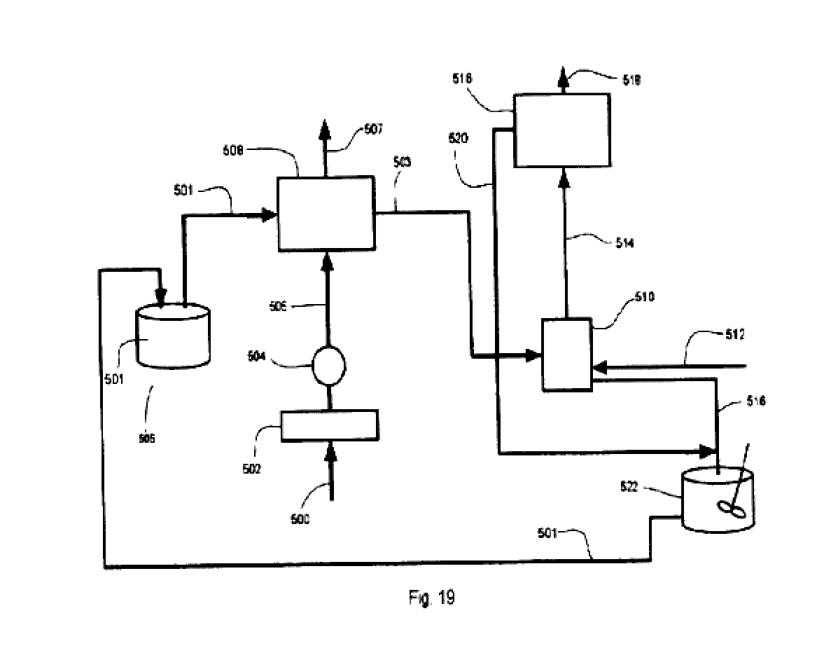

FIG. 19 shows these absorption and regeneration steps as well as the use of an optional dehumidifier (for example, a molecular sieve) and an optional exhaust gas cooler.

Turning to FIG. 19, untreated exhaust gas 500 carrying SO₂ is first prepared by passage through a molecular sieve 502 and a cooling element 504. The molecular sieve 502 acts to remove moisture from the exhaust gas 500. As a result, a dry, cooled exhaust gas 506 (carrying SO₂) enters the ceramic membrane scrubber 508.

The system as illustrated first passes the untreated exhaust gas 500 through a molecular sieve 502 before cooling in cooling element 504, and this is generally the preferred embodiment. However, the exhaust gas could be cooled before being dehumidified, and any combination of apparatus that results in a dry, cooled exhaust gas 506 may be used. Furthermore, the system will work without either dehumidification or cooling of the exhaust gas.

The use of a cooling element 504 is not necessary. However, the removal of SO₂ from the gaseous to the liquid phase in ceramic membrane scrubber 508 increases in efficiency as the temperature difference between dry, cooled exhaust gas 506 and carrier liquid 501 is decreased. This gain in efficiency is desirable. Generally, it is more efficient to cool the exhaust gas 500 than to heat carrier liquid 501 to gain this efficiency.

Returning to FIG. 19, there is provided a buffer tank 505. This tank contains the carrier liquid 501 which comprises:

H₃PO₄+NaOH [symbol] Na₂HPO₄+2H₂O (I)

The carrier liquid 501 is passed through the ceramic membrane scrubber 508 where it encounters gaseous SO₂ entering the ceramic membranes from dry, cooled exhaust gas 506. Upon encountering the SO2, a chemical reaction occurs so that the carrier liquid upon exiting the ceramic membrane scrubber 508 comprises exit liquid 503:

H₃PO₄+NaOH [symbol] Na₂HPO₄+2H₂O (I)

and

Na₂HPO₄+SO₂+H₂O [symbol] NaSO₃+NaH₂PO₄ (II)

The SO₂ is now in liquid form. Exit exhaust gas 507 has a lower concentration of SO₂ than dry, cooled exhaust gas 506.

The liquid 503 is taken to siphon-type evaporator 510, which is heated by steam 512 or another suitable source of heat. Evaporator 510 separates the liquid 503 into a gaseous phase 514 containing SO₂+H₂O and a liquid phase 516 containing Na₂HPO₄. Generally, several types of evaporators may be used for this step. The gaseous phase 514 is condensed in condenser 516 to produce gaseous SO₂ 518 and liquid H₂O 520.

Gaseous SO₂ 518 can then be dealt with as desired. Typically, the captured gaseous SO₂ 518 is taken to a sulphur recovery unit; more generally, it can be stored or treated and released or converted to a useful form. The gaseous SO₂ 518 may, for example, be converted to sulphuric acid.

Liquid H₂O 520 is mixed with liquid Na₂HPO₄ 516 in tank 522. Since the liquid Na₂HPO₄ 516 contains heat provided by siphon-type evaporator 510 and the liquid H₂O 520 contains heat from condenser 516, the liquid Na₂HPO₄ 516 and liquid H₂O 520 will react to regenerate liquid carrier liquid 501:

H₃PO₄+NaOH [symbol] Na₂HPO₄+2H₂O (I)

For greater efficiency, the contents of tank 522 may be mixed or agitated.

In order for heat exchanger 510 to create gaseous SO₂ and H₂O, the carrier liquid will have to be heated to between 100 and 250 degrees Celsius. To condense the water, gaseous stream 514 should be cooled below 100 degrees Celsius. Such a system should be able to produce an SO₂ stream of approximately 90-95% purity.

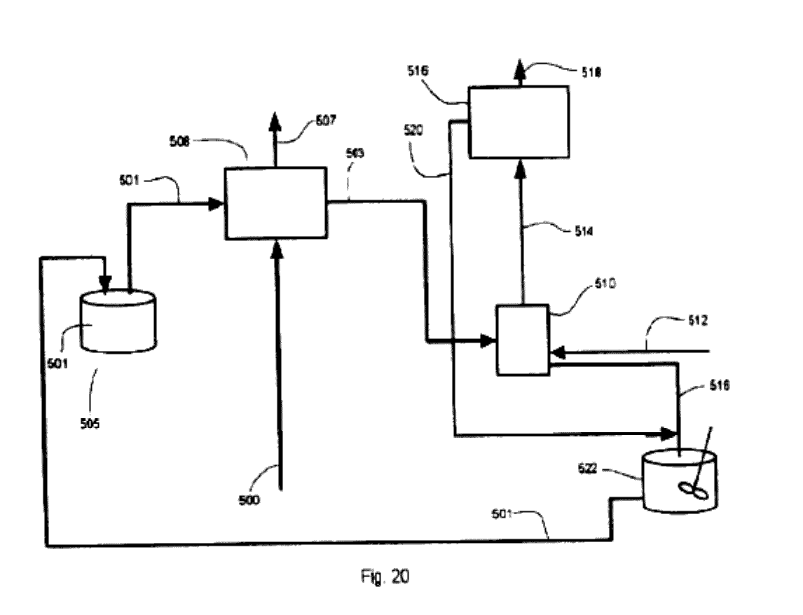

As noted above, the system illustrated in FIG. 19 may be operated without the dehumidification and cooling of the exhaust gas. FIG. 20 illustrates the same system as in FIG. 19, but without the molecular sieve 502 and a cooling element 504. The system in FIG. 20 otherwise operates identically to the system in FIG. 19.

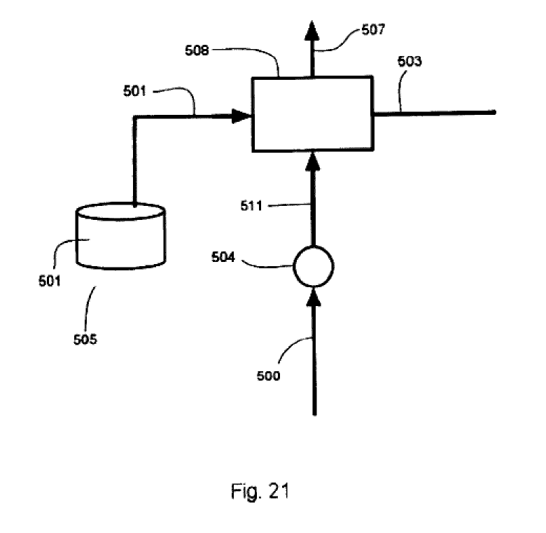

In one specific example, using the setup illustrated in FIG. 21 (where like numbers indicate like parts to those in FIGS. 19 and 20), exhaust gas 500 is between 110-200 degrees Celsius, enters the system at a rate of 100-160 cc/min, and has an SO₂ concentration of around 250 ppm. Cooled (but not dried) exhaust gas 511 has been cooled to between 70-80 degrees Celsius. Carrier liquid 501 is between 30-40 degrees Celsius, entering the scrubber at a rate of 10-30 cc/min, with a ratio of H₃PO₄ to NAOH of 0.66-1.5. Exit carrier liquid 503 has a raised temperature between 35-45 degrees Celsius, but the same flow rate of 10-30 cc/min. Exit gas 507 has dropped in temperature to between 65-75 degrees Celsius at the same flow rate of 100-160 cc/min, and has an SO₂ concentration of around 25 ppm.

A TEG scrubber system with a regenerated carrier liquid can also unexpectedly be usefully incorporated into a larger system that assists with the long-standing problem of fuel efficiency on marine transport ships. The specific example disclosed below is an SO₂ scrubber using aqueous NaOH as a regenerable carrier liquid.

Transport ships use very heavy (and dirty) fuel, typically Heavy Fuel Oil (HFO); heavier than those used for trucks or other land transport. Very heavy fuels do not burn efficiently. It is known to inject H₂ or O₂ gas into the fuel to increase the efficiency of heavy fuel; however, this approach is disfavoured on marine transport vessels since marine transport is a cost-sensitive undertaking and it costs more to generate or store or otherwise provide the H₂ or O₂ gas than the energy benefit from H₂ or O₂ injection. Even on land-based engines, which are generally less cost-sensitive, hydrogen injection is not commonly used, and there are greater cost sensitivities in marine engines. Hydrogen and oxygen injection would be particularly useful in a marine transport context compared to a land context since engines are often run at full power in marine contexts (where hydrogen and oxygen injection would be most useful) while this rarely occurs in land transport systems.

However, if a regenerative carrier-liquid system is used for the removal of TEGs that generates H₂ and/or O₂ gas as a waste product, the waste H₂ and/or O₂ gas can be used for injection with the HFO to increase the efficiency of the fuel burning. This solves the cost/thermodynamic issues with H₂ or O₂ gas generation, since the cost is justified by the decrease in TEGs in the ship exhaust.

A regenerative system can be implemented using aqueous NaOH as the carrier liquid and an electrolyzer to regenerate the NaOH. It is desirable to implement such a system (regardless of whether H₂ and/or O₂ injection is incorporated) for the reasons discussed above: it reduces the weight of carrier liquid onboard and reduces the space requirements for storing the carrier liquid, allowing the ship to carry more revenue-generating cargo.

In addition, the regenerative aqueous NaOH system can be designed to generate and collect hydrogen (H₂) gas (and oxygen gas), which can be injected into the transport ship's heavy fuel (typically HFO) stream to assist in efficient burning of the fuel, increasing the ship's engines's fuel efficiency. Given the overwhelming concern with minimizing costs, including minimizing fuel costs, in water-based transport industry, this is a significant advantage.

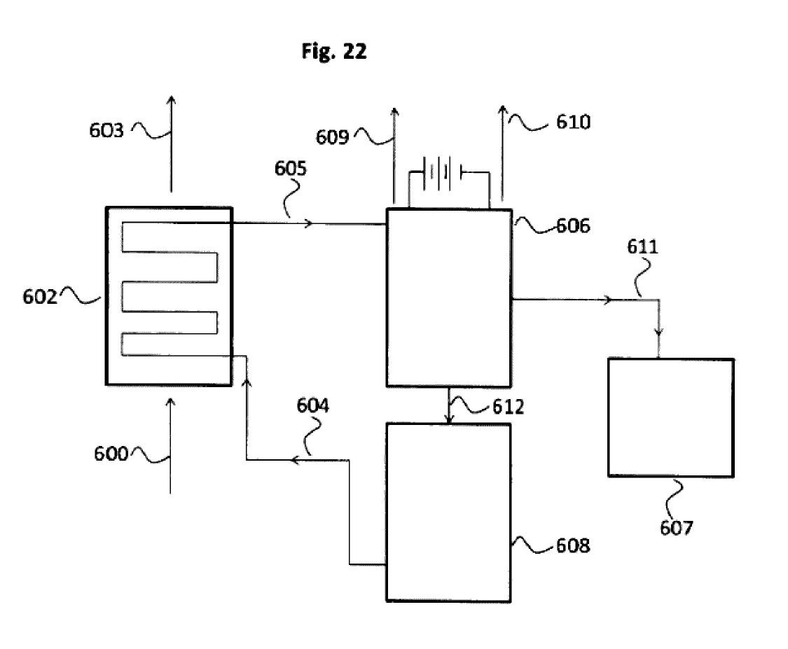

Turning to FIG. 22, exhaust containing SO₂ 600 passes through membrane scrubber 602 (which is generally similar to the scrubbers described above), resulting in an exhaust gas 603 with a lower level of SO₂. Entering into the scrubber is a carrier liquid 604 which is a mixture of NaOH and H₂O (in practice, over time as the carrier liquid circulates this stream will also contain small amounts of sulfur-bearing compounds). Exiting the scrubber is an aqueous solution 605 of NA₂SO₄ along with H₂O and unreacted NaOH.

In greater detail, inside the scrubber the reaction

2NaOH+SO₂ [symbol] Na₂SO₃+H₂O
will remove SO2 from the gaseous stream into the carrier liquid. However, the Na₂SO₃ will swiftly oxidize into Na₂SO₄.

Although this system is designed to remove SO₂ from the exhaust gas, the carrier may well remove some COX and NOX impurities as well.

The aqueous solution 605 passes into electrolyzer 606, where it undergoes an electrochemical reaction to generate sulphuric acid (H₂SO₄) and sodium hydroxide (NaOH). The sulfuric acid 611 is sent to a holding tank 607, where it can be stored (and eventually sold or otherwise used), or in some situations diluted and discharged. The regenerated NaOH 612 is sent to a sodium hydroxide holding tank 608, at which point it may recirculated through scrubber 602.

The electrolyzer 606 will also generate hydrogen gas 609 and oxygen gas 610 as a byproduct of the NaOH regeneration system. From the point of view of the SO₂ scrubber and the NaOH regeneration system, hydrogen gas 609 and oxygen gas 610 are waste gases that can be released into the atmosphere. However, it is more advantageous to feed these back into the heavy fuel marine engines of the ship, increasing fuel efficiency. In essence, the electrochemical system, and more broadly the SO₂ scrubber system, becomes part of the engine system.

In a specific embodiment, the hydrogen and oxygen streams are mixed before introduction into the heavy fuel marine engine as wet hydrogen gas.

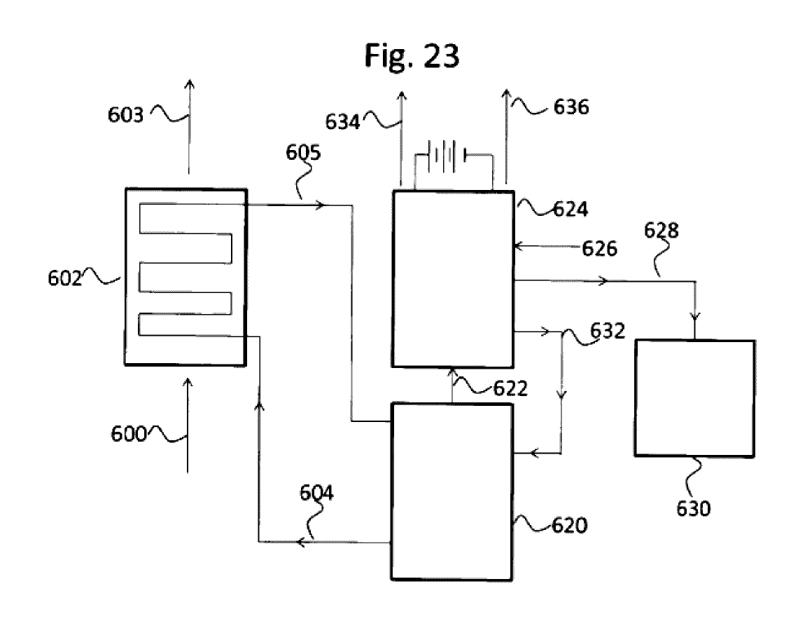

A different approach is illustrated in FIG. 23. Turning to FIG. 23, exhaust containing SO₂ 600 passes through membrane scrubber 602 (which is generally similar to the scrubbers described above), resulting in an exhaust gas 603 with a lower level of SO₂. Entering into the scrubber is a carrier liquid 604. When the system is first started, carrier liquid 604 is a mixture of NaOH and H₂O. Exiting the scrubber is an aqueous solution 605 of sodium sulfate with NA₂SO₄ along with H₂O and unreacted NaOH.

In greater detail, inside the scrubber the reaction

2NaOH+SO₂ [symbol] Na₂SO₃+H₂O
Will remove SO2 from the gaseous stream into the carrier liquid. However, the Na₂SO₃ will swiftly oxidize into Na₂SO₄.

Although this system is designed to remove SO₂ from the exhaust gas, the carrier may well remove some COX and NOX impurities as well.

The aqueous solution 605 passes into NaOH tank 620, where crystals of Na₂SO₄ can be extracted. Generally, the Na₂SO₄ is extracted by cooling incoming stream 605 which under proper conditions causes a precipitate to form. However any other method of extracting Na₂SO₄ including other approaches to cause crystallization known to those in the art, including seeding, could be used.

The crystallized Na₂SO₄ is passed with water (labelled 622 in FIG. 23) into the electrolyzer 624, where it undergoes an electrochemical reaction to generate sulphuric acid (H₂SO₄) and sodium hydroxide (NaOH). Additional water 626 can be introduced to the electrolyzer as needed to support the reaction. The sulfuric acid 628 is sent to a holding tank 630, where it can be stored (and eventually sold or otherwise used) or in some situations diluted and discharged. The regenerated NaOH 632 is sent to a sodium hydroxide holding tank 620, at which point it may be recirculated through scrubber 602.

Unless a method is implemented to recover 100% of the Na₂SO₄ as crystals, once the carrier liquid starts circulating carrier liquid 604 will also include Na₂SO₄. In a specific embodiment, Na₂SO₄ is crystallized by cooling aqueous solution 605; in such an embodiment once the scrubber is initialized, Na₂SO₄ will build in concentration in streams 604 and 605 until the concentration in stream 605 reaches the saturation concentration of Na₂SO₄ (which is dependent on the temperature to which stream 605 is cooled). At that point, crystals of Na₂SO₄ will precipitate and will be passed to electrolyzer 624 for the regeneration process, and input carrier liquid 604 will contain Na₂SO₄ at just below the saturation concentration (depending on whether extra NaOH and/or water is added to tank 620 and the flow rate of NaOH stream 632).

In a specific embodiment, the crystallization temperature is between 20-45 degrees Celsius. In a preferred embodiment, the crystallization temperature is around 35 degrees Celsius.

As compared to the embodiment in FIG. 22, the embodiment in FIG. 23 provides a more efficient regeneration of the NaOH; however, this comes with a cost of greater capital investment (i.e. investment in an extraction process) and complexity.

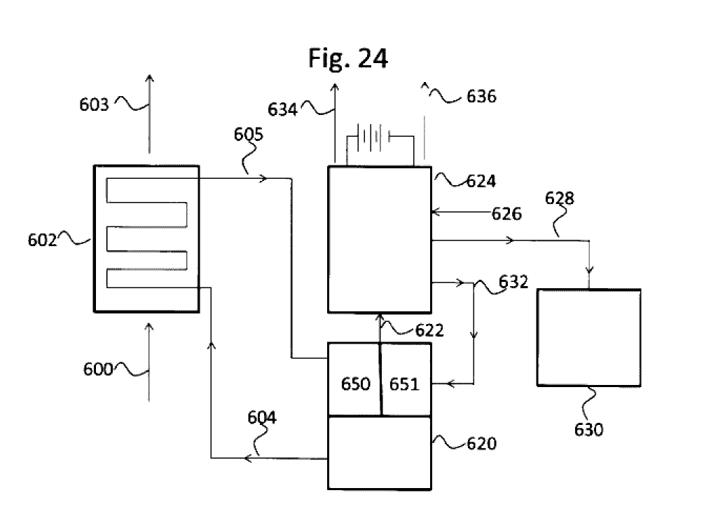

In an alternative embodiment illustrated in FIG. 24, tank 620 is split into three separate sections 650, 651 and 652. The first section 650 fills with stream 605 until a certain level is reached, at which point (i) stream 605 is directed into the second section 651, and (ii) the contents of the first section 650 are sent to electrolyzer 624 for generation of sulphuric acid (H₂SO₄) and sodium hydroxide (NaOH). Additional water 626 can be introduced to the electrolyzer as needed to support the reaction. The sulfuric acid 628 is sent to a holding tank 630, where it can be stored (and eventually sold or otherwise used) or in some situations diluted and discharged. The regenerated NaOH 632 is sent to a sodium hydroxide holding section 652, at which point it may be recirculated through scrubber 602. Meanwhile, the second section 651 fills with stream 605 until a certain level is reached, at which point (i) stream 605 is directed into the first section 650, and (ii) the contents of the second section 651 are sent to electrolyzer 624 for generation of sulphuric acid (H₂SO₄) and sodium hydroxide (NaOH). Sections 650 and 651 continue to alternate in this manner. Using this approach, it is not necessary to crystallize Na₂SO₄ before passing the carrier liquid to the electrolyzer, although it may be useful in some cases. In an alternative embodiment, one or more of sections 650, 651 and 652 are implemented as separate tanks.

In the embodiments of FIGS. 22-24 and accompanying text, the electrolyzer 624 will generate hydrogen gas 634 and oxygen gas 636 as a byproduct of the NaOH regeneration system. From the point of view of the SO₂ scrubber and the NaOH regeneration system, hydrogen gas 634 and oxygen gas 636 are waste gases that can be released into the atmosphere. However, it is more advantageous to feed one or both of these back into the heavy fuel marine engines of the ship, increasing fuel efficiency.

In a specific embodiment, the hydrogen and oxygen streams are mixed before introduction into the heavy fuel marine engine as wet hydrogen gas, although this should be done with caution as hydrogen gas is explosive.

The electrolyzer 606 or 624 may be constructed in several ways known in the art. The electrolyzer may use one or more ion exchange membranes, and use multiple anode and cathode cells. It may use processes of electrodialysis or electrolysis. The electroyzer may be run as a batch or continuous process, although a continuous process is preferred for the present application. For greater efficiency, it may use circulating anolyte and catholyte fluids, as seen for example in U.S. Pat. No. 5,230,779 of Martin, which is incorporated by reference. (Note that in the case of electrolyzer 624 and crystallized Na₂SO₄, it may be necessary to add a filter to prevent clogging of pumps if using a circulating anolyte).

In many applications, the generation of chlorine radicals (for example, from the salt splitting of NaCL bearing seawater) creates issues with the disposal of the chlorine, and increased degradation and maintenance or replacement costs for the electrolyzer. In this process, by design, a sulfate is split instead of a chlorate, resulting in advantages over a chlorate-based system.

The choice of a specific electrolyzer depends upon the constraints of the specific application, and is heavily affected by application in the marine transport industry. A marine transport ship is a closed system, and minimizing storage and carrying costs for chemicals is a priority. For example, batch processes are likely to be more efficient than continuous processes; however, electrolyzing as part of a continuous process removes the need to store extra catholyte or anolyte.

On a related note, electrolysis is more power-intensive but has a more efficient separation, while electrodialysis uses less power, but provides a less efficient separation. The choice between these approaches depends in part upon the electric power (and associated costs) available on a given ship.

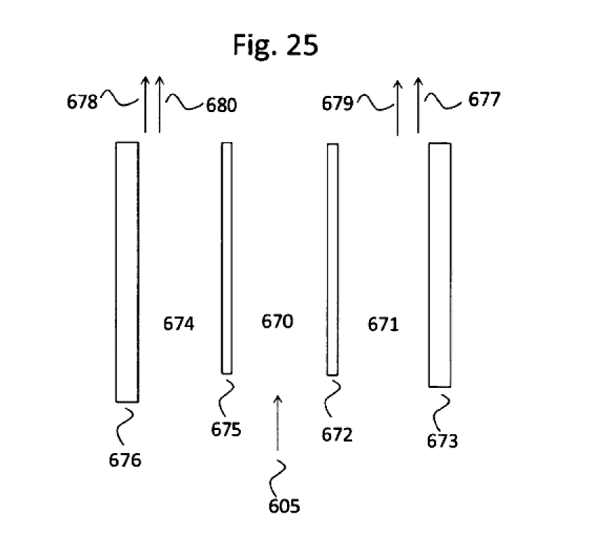

In one preferred embodiment, a three cell electrolyzer with an anion exchange membrane and a cation exchange membrane is used. Turning to FIG. 25, the aqueous solution 605 of sodium sulfate with NA₂SO₄ along with H₂O and unreacted NaOH 605 enters cell 670. Between cell 670 and cell 671 is cation exchange membrane 672, and cell 671 is equipped with cathode 673. Between cell 670 and cell 674 is anion exchange membrane 675, and cell 674 is equipped with anode 676. When the current is engaged, sodium will pass through the cation exchange membrane 672 and form NaOH 679 in cell 671, with a hydrogen gas byproduct 677. Simultaneously, the SO4 will pass through the anion exchange membrane and form sulphuric acid (H₂SO₄) 680 with an oxygen gas byproduct 678. This electrolyzer may be run in either a batch or continuous mode.

As may be seen in Tables 1 and 2, an electrolyzer-based NaOH regeneration system will be cost effective simply on the basis of savings as compared to purchasing NaOH. However, this underestimates the cost advantages of the systems disclosed above, since it does not include the advantages of hydrogen and oxygen injection into the ship's engines or the benefit of selling (or otherwise making use of) the resulting sulfuric acid.

TABLE 1
Electrodyalisis

| | Mg Na₅SO₄ | amount | | | | | | | | |
|---|---|---|---|---|---|---|---|---|---|---|
| Engine | produced per | NaOH | | | cell | | cost to run | | | Payback |
| size | hour by the | produced | Cell cost | | power | cell power MW/ | cell/hour | Value of NaOH | Payback | Years based |
| MW | scrubber | by the cell | million | cost/MW | consumption | engine MW | @ $.1/KWh | at $1000/ton | in hours | 2,000 hr/year |
| 10 | 275 | 154 | $3 | 0.3 | 0.4 | 0.04 | $40 | $275 | 10.505 | 5.5 |
| 15 | 480 | 248 | $8 | 0.3125 | 0.8 | 0.0375 | $60 | $440 | 11.384 | 3.7 |
| 40 | 1200 | 615 | $9 | 0.225 | 1.4 | 0.035 | $140 | $1,100 | 4.182 | 4.1 |

TABLE 2
Electrolysis

| | Mg Na₅SO₄ | amount | | | | | | | | |
|---|---|---|---|---|---|---|---|---|---|---|
| Engine | produced per | NaOH | | | cell | | cost to run | | | Payback |
| size | hour by the | produced | Cell cost | | power | cell power MW/ | cell/hour | Value of NaOH | Payback | Years based |
| MW | scrubber | by the cell | million | cost/MW | consumption | engine MW | @ $.1/KWh | at $1000/ton | in hours | 2,000 hr/year |
| 10 | 275 | 154 | $6 | 0.6 | 0.6 | 0.06 | $50 | $275 | 21.855 | 10.9 |
| 15 | 440 | 246 | $9 | 0.5625 | 1 | 0.0625 | $300 | $440 | 20.455 | 10.2 |
| 40 | 1100 | 615 | $10 | 0.25 | 2.5 | 0.0825 | $250 | $3,100 | 9.091 | 4.5 |

Tests have been run to determine preferred operating conditions for scrubber 20 when removing SO₂ from a gas stream using an aqueous NaOH based carrier liquid. These results will generally apply to any arrangement of scrubber modules, including combinations of parallel and series arrangements, and as described elsewhere in this application. Except at relatively extreme conditions, the preferred operating conditions for the gas stream and for the liquid carrier are largely independent.

Scrubber 20 operates using diffusion, drawing TEGs from the gas to the liquid carrier. The efficiency of the scrubber depends on keeping a sufficient concentration gradient between the gas and the carrier liquid at the point of contact: the outer diameter of the bore in the ceramic membranes. In respect of the carrier liquid, this occurs when the carrier liquid in the bores is turbulent.

Preferred conditions for the aqueous NaOH based carrier liquid (assuming a maximum SO2 gas inlet concentration of 700 ppm) are: an aqueous NaOH concentration at start-up of at least 11 wt % and a temperature between 20 and 40 degrees Celsius and a minimum carrier liquid flow rate of 0.6 meters/second. As the wt % of NaOH in the carrier liquid increases, it becomes increasingly difficult to pull the carrier liquid through the bores at a turbulent rate, so a more preferred concentration at start-up of between 11 wt % to 20 wt %. A still more preferred concentration at start-up of between 12 wt % to 15 wt %. A particularly preferred NaOH concentration at start-up is 13 wt %. A more preferred temperature range for the carrier liquid is between 30 and 40 degrees Celsius. A particularly preferred temperature is 35 degrees Celsius.

Preferred conditions for the inlet gas are a temperature between 90 and 250 degrees Celsius. In another preferred embodiment, the temperature of the inlet gas is less than 120 degrees Celsius. However, since the exhaust gas to be treated is typically hot, cooling the gas to this range may be uneconomical. In a more preferred embodiment is the inlet gas having a temperature between 120 and 200 degrees Celsius. In a still more preferred embodiment, the inlet gas has a temperature between 125 and 150 degrees Celsius. In a particularly preferred embodiment, the temperature of the inlet has is 135 degrees Celsius.

The preferred speed of the inlet gas is a maximum flow speed over the membranes of 79 ft/minute. As a general matter, the slower the speed of the gas over the membranes, the better the mass transfer of SO2 into the carrier liquid. Another preferred embodiment is a maximum flow speed over the membranes of 58 ft/minute. A more preferred embodiment is a maximum flow speed over the membranes of 50 ft/minute. A more preferred embodiment is a maximum flow speed over the membranes of 29 ft/minute. A particularly preferred embodiment is a maximum flow speed over the membranes of 15 ft/minute.

In a particularly preferred embodiment, the optimum NaOH concentration is 13 wt %, the optimum temperature of the carrier liquid is 35 degrees Celsius, the maximum gas speed is 60 ft/min over the membranes, the minimum carrier liquid flow rate is 0.6 meters/second, the maximum SO2 inlet concentration is 700 ppm, and the maximum gas temperature is 120 degrees Celsius.

In another particularly preferred embodiment, the optimum NaOH concentration is 13 wt %, the optimum temperature of the carrier liquid is 35 degrees Celsius, the maximum gas speed is 15 ft/min over the membranes, the minimum carrier liquid flow rate is 0.6 meters/second, the maximum SO2 inlet concentration is 700 ppm, and the maximum gas temperature is 120 degrees Celsius. The test data to support these ranges are disclosed below. The experimental conditions, apart from the independent variable on the horizontal axis, area those given immediately above as the particularly preferred embodiment.

In several embodiments of this invention, an aqueous-based carrier is used, and a holding tank (for example, tank 608 in FIG. 22) is used to collect the carrier for re-circulation. Experiments have shown that if the temperature of the inlet carrier stream into the scrubber (for example, stream 604 in FIG. 22) is sufficiently high, water will evaporate out of the carrier stream through the ceramic membranes and out through the exhaust stream (for example, 603 in FIG. 22). If the temperature of the inlet carrier stream into the scrubber (for example, stream 604 in FIG. 22) is sufficiently low, water will condense out of the exhaust gas stream (for example, 600 in FIG. 22) through the ceramic membrane and into the exit carrier liquid (for example, 605 in FIG. 22). This will result in an increase or decrease of water accumulating in the holding tank.

As a result, the temperature of the carrier inlet stream (for example, 604 in FIG. 22) can be used to control the amount of water in the holding tank (for example, 608 in FIG. 22) or equivalently, the concentration of the components of the exit carrier steam (for example, 605 in FIG. 22). This can be used, for example, to prevent the holding tank from filling up or otherwise running in an inefficient manner.

In an experiment, it was observed that at an inlet carrier stream of approximately 30 degrees Celsius, the water in the holding tank did not appreciably accumulate. Accumulation of water started to occur when the inlet carrier stream was cooled to under 25 degrees Celsius, and loss of water was observed when the inlet carrier stream was heated to 35 degrees Celsius. From a water loss perspective, it was therefore observed that running with the temperature of the carrier inlet stream between 25 and 35 degrees Celsius was preferred.

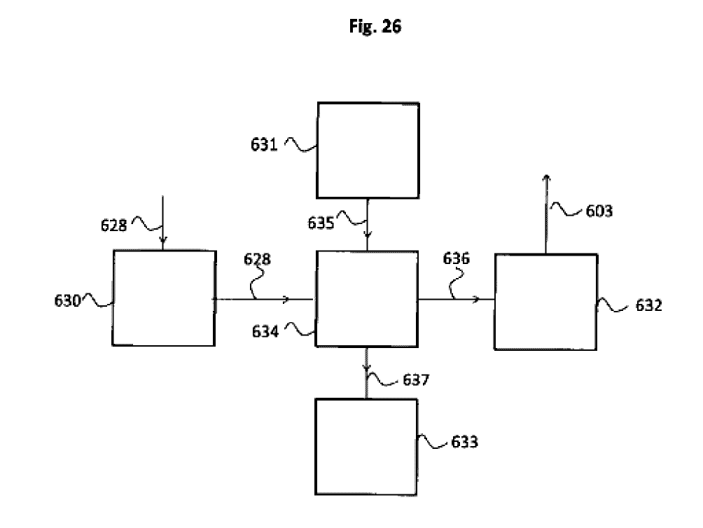

In an optional additional embodiment illustrated in FIG. 26, sulfuric acid 628 generated by the electrolytic regeneration of diesel emission scrubber solution is used to pre-treat marine heavy fuel oil 635 from the ship's fuel tank 631 before it is injected into the engine 632. (As described above and illustrated in Figured 23 and 24, sulfuric acid 628 can be generated when Na₂SO₄ is formed when SO₂ reacts with NaOH, K₂SO₄ is formed when SO₂ reacts with KOH, or some other SO₂ absorbing agents, absorbents, liquid absorbents or scrubbing agents react with SO₂ to form a compound that can be electrolyzed with H₂SO₄ as a product) This pretreatment mixes the heavy fuel oil 635 with H₂SO₄628 in a mixer 634.

Mixer 634 is configured to facilitate soot removal. The main source of soot formation in the heavy fuel 635 are alkenes. Sulfuric acid 628 when mixed with the heavy fuel 635 converts alkenes into alkyl hydrogensulphates, which settles out as sludge 637 and is stored in a sludge tank 633. In addition, aromatic hydrocarbons (CNH(2N-6)) in heavy fuel 635 are very stable under heat, are chemically active to a moderate degree, and contain a higher proportion of carbon than the other hydrocarbon types. Sulfuric acid 628 converts aromatics in heavy oil 635 (which are non-combustable) to aromatic sulfonic acids, which settles out as sludge 637. Finally, sulfuric acid 628 also reacts with heavy metals in marine heavy fuel oil 635, forming metal sulfites which settles out as sludge 637 and stored in a sludge tank 633.

The resulting treated fuel 363, when burned in the engine 632, produce a cleaner, less polluting combustion exhaust gas 603. The addition of H₂SO₄ to the marine fuel 635 allows for the conversion of aromatics (arenes) and alkenes within the fuel to compounds that are no longer considered a contaminant, impurity, or pollutant when the fuel is burned. This results in cleaner combustion exhaust gas 603. In addition, the derivatives of sulfanilic acid can also be filtered from the fuel, removing soot metals before they are burned in the combustion chamber, further reducing pollutants typically found in engine exhaust 603.

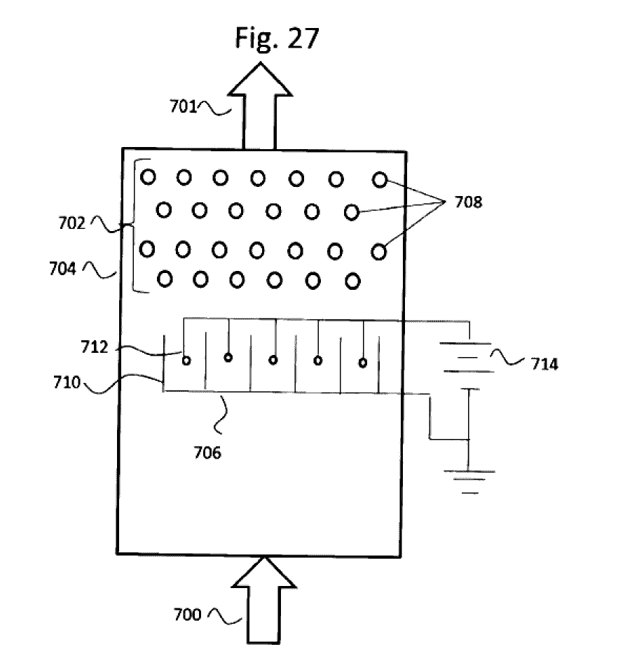

In a further embodiment, an electrostatic charge is applied to the exhaust gas upstream of the membrane array. Turning to FIG. 27, incoming gas exhaust 700 passes through membrane array 702 in scrubber 704. Upstream of the membrane array 704, the exhaust gas passes through an electrostatic generator 706. The electrostatic generator 706 imparts a (positive or negative) charge to the TEG molecules, and all other molecules in gas exhaust 700. The charged TEG molecules and other charged molecules are then attracted to the ceramic tubes 708 in membrane array 702, which are ground relative to the charged particles. This increases the efficiency of the transfer of TEG molecules into the carrier.

In the illustrated embodiment, electrostatic generator 706 consists of charge plates 710, charge wires 712 and a DC power supply 714. However, other types of electrostatic generators 706 known to persons skilled in the art may be used.

Prior art separators that use electrostatic air filters or other electrostatic separation typically have a deposit or collection plate or a filter on which materials to be separated accumulate. This plate or filter must be replaced or cleaned to prevent fouling of the separation unit.

In contrast, the present invention uses a continuous flow of carrier separated from the gas stream by a membrane to carry away the materials to be separated. This greatly reduces the maintenance costs to run the electrostatic separator, since the ceramic membranes will not foul as quickly as a deposit or collection plate, filter or similar structure. As discussed above, the carrier may be chosen to promote the separation of specific materials to be separated. From this point of view, the membrane separator described herein is an inventive electrostatic separator that can be used to separate materials from a gas stream for many purposes other than marine transport, including any purposes that presently utilize an electrostatic separator.

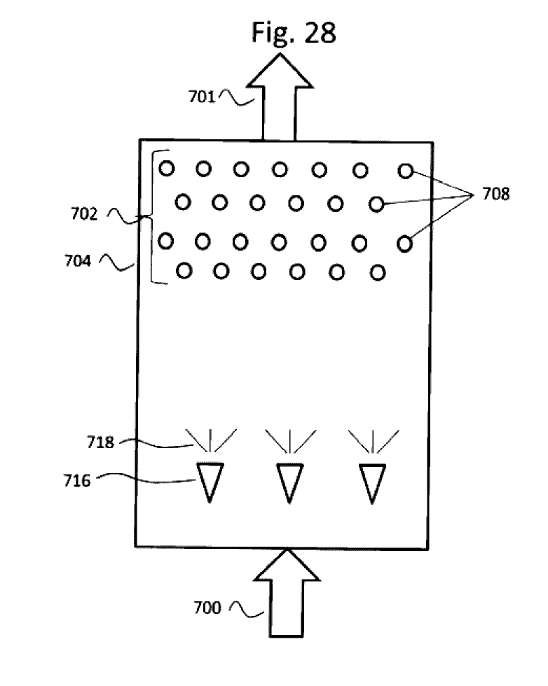

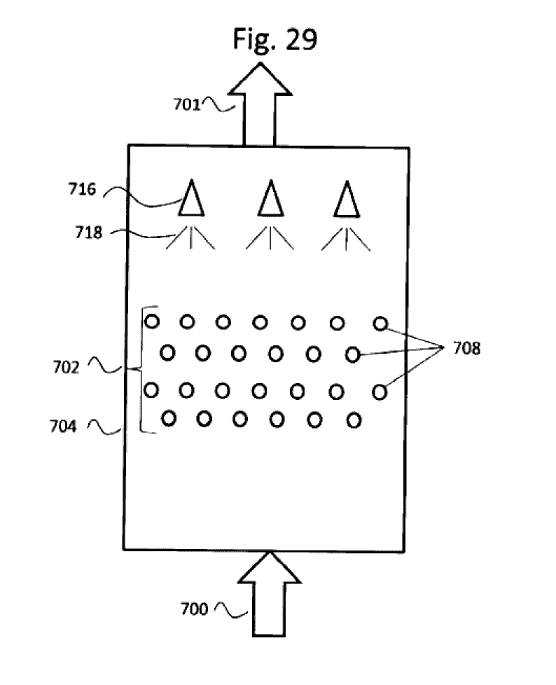

In a further embodiment, atomized NaOH, KOH or other carrier may be sprayed into the exhaust gas upstream or downstream (or both upstream and downstream) of a membrane array. Turning to FIGS. 28 and 29, incoming exhaust gas 700 passes through membrane array 702 in scrubber 704. Turning to FIG. 28, atomizing nozzles 716 spray an atomized carrier 718 into the incoming gas 700. In general, atomized carrier 718 will be the same as (or convert to) a component of the carrier in membrane array 702. For example, atomized carrier 718 could be aqueous NaOH, which when sprayed into exhaust gas 700 binds with some of the TEGs. The aqueous NaOH and bound TEGs upon encountering the ceramic membrane tubes 708 will contact the ceramic membranes and the droplets of NaOH with bound TEGs will be absorbed, and the aqueous NaOH and bound TEGs will pass into the carrier.

Generally, spraying aqueous NaOH works well with a system where the carrier is NaOH based. In practice, as discussed above, the carrier will not be pure NaOH, but will be a mixture of NaOH inter-converted with TEG compounds.

In embodiments where there are concerns over the NaOH being consumed by the TEG conversions, this process can be used to replenish the NaOH in the carrier.

Alternatively, the atomized carrier 718 could be a carrier designed to capture a specific TEG, as long as the atomized carrier 718 can mix with the carrier in membrane array 702 without causing significant deterioration in the operation of the scrubber.

Although the description above describes the carrier 718 as atomized, the carrier can also be turned into an aerosol or, in some conditions, a vapour or a gas. The droplet size can be tuned, for example to ensure that they become entrained in the exhaust stream, or in another example to control whether they do or do not evaporate before encountering the membrane array.

In a particular embodiment, the carrier 718 is ozone, and the ozone acts to oxidize the TEGs, for example converting NO to NO₂. Oxidized forms of the TEGs are less stable and more easily absorbed into the carrier in membrane array 702.

Turning to FIG. 29, the nozzles 716 may also be placed downstream of the membrane array 702. In such cases, the droplet size is tuned so that the liquid 718, bound to TEG particles, will fall into the membrane array 702 an be absorbed as discussed above.

In an alternative embodiment, nozzles 716 spraying atomized carrier 718 are placed downstream and upstream of a membrane array 702. In an embodiment where there are multiple membrane arrays in series, nozzles 716 spraying atomized carrier 718 may be placed between the membrane arrays.

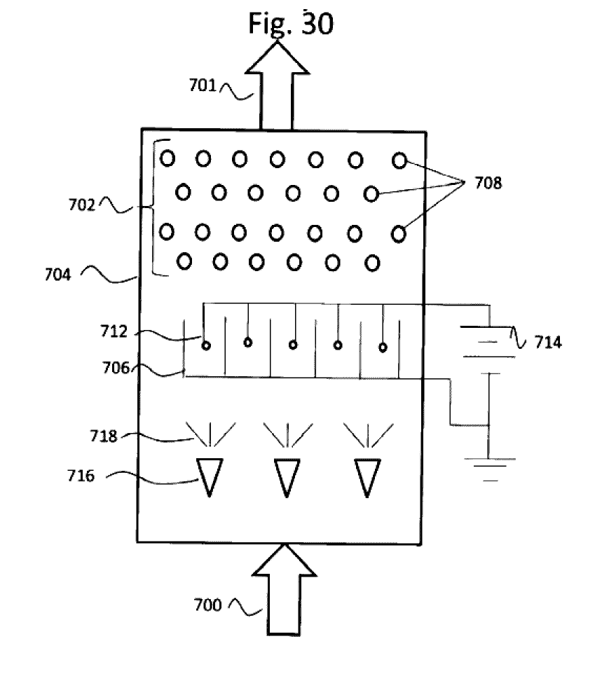

In further embodiments, the spraying of a carrier 718 can be combined with a device to impart an electrostatic charge. Turning to FIG. 30, incoming exhaust gas 700 passes through membrane array 702 in scrubber 704. Upstream of the membrane array 704, the exhaust gas passes by nozzles 716 which spray atomized carrier 718 into the gas. The exhaust gas then passes through an electrostatic generator 706. The electrostatic generator 706 imparts a (positive or negative) charge to the TEG molecules and also to the droplets of carrier 718. The charged TEG molecules and droplets of carrier 718 (some of which are bound to TEGs) are then attracted to the ceramic tubes 708 in membrane array 702, which are ground relative to the charged particles.

Although the electrostatic generator 706 must be placed upstream of at least one membrane array to be effective, the nozzles 716 may be placed before or after the electrostatic generator while still being upstream of the membrane array. In another embodiment, the nozzles 716 are placed downstream of a membrane array. If the nozzles 716 are downstream of all the membrane arrays, the droplet size is tuned so that the liquid 718, some of which will be bound to TEG particles, will fall into the membrane array 702 and be absorbed as discussed above. In an alternative embodiment, nozzles 716 spraying atomized carrier 718 are placed both upstream and downstream of a membrane array 702. In an embodiment where there are multiple membrane arrays in series, nozzles 716 spraying atomized carrier 718 may be placed between the membrane arrays. In an embodiment where there are multiple membrane arrays in series, electrostatic generator(s) 706 may be placed between the membrane arrays.

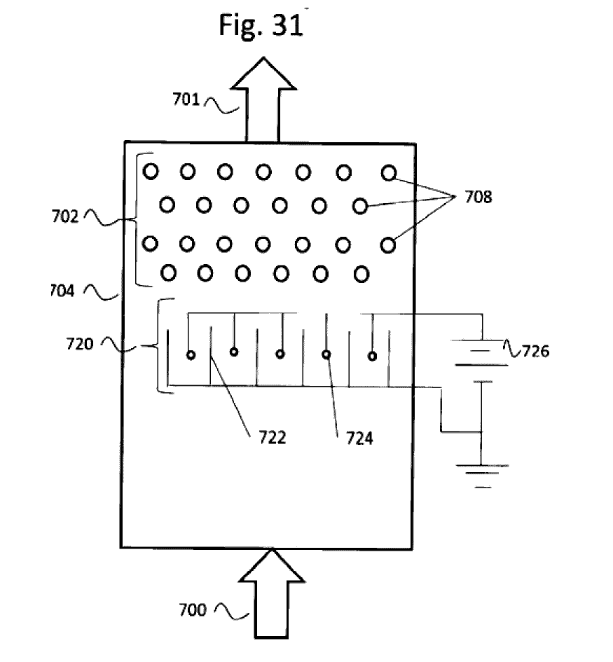

In an alternative embodiment, a pulsed corona is used to create a low temperature plasma, increasing the energy state of the particles in the exhaust gas. Turning to FIG. 31, incoming exhaust gas 700 passes through membrane array 702 in scrubber 704. Upstream of the membrane array 702, the exhaust gas passes through a pulsed corona generator 720. The pulsed corona generator 720 increases the energy state of the particles in exhaust stream 700. In a higher energy state, the TEGs are more readily absorbed by the carrier in membrane array 702.

For example, some of the NO upon encountering the pulsed corona will be converted to NO₂. While NO is generally insoluble, NO₂ is more soluble which will be an advantage if used with an aqueous NaOH carrier system. Also, NO₂ will react more quickly and efficiently with the carrier than NO, for example in the aqueous NaOH carrier systems generally described above. Conversion from NO to NO2 provides both physical (i.e. solubility) and chemical (i.e. faster and more efficient reaction) benefits upon encountering the carrier in membrane array 702.

Similarly, SO₂ is converted to SO₃; CO₂ is converted to CO₃ The more oxidized form of the TEGs are less stable and more easily absorbed by the carrier in membrane array 702.

In this way, the corona acts as a pre-treatment to make the TEGs more readily absorbed into the carrier in membrane array 702. The use of a pulsed corona is suited as a pre-treatment device for marine applications because the corona-generating apparatus is compact.

However, use of a corona is usually considered impractical for marine operations since existing corona separators use filter bags to capture the NO₂ or other undesirable materials, which is impractical in a marine environment. In contrast, the described systems use the membrane absorber to capture the NO₂ or other TEGs in an excited state. From this point of view, the membrane separator described herein is an inventive corona-based separator that can be used to separate materials from a gas stream for many purposes other than marine transport, including any purposes that presently utilize an corona-based separator.

In the illustrated embodiment, pulsed corona generator 720 consists of charge plates 722, charge wires 724 and a pulsed DC power supply 726. However, other types of pulsed corona generators 720 known to persons skilled in the art may be used, including but not limited to laser excitement systems.

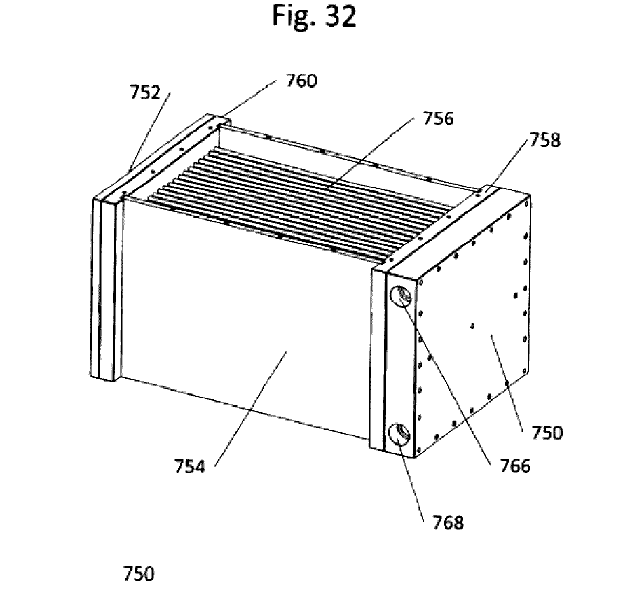

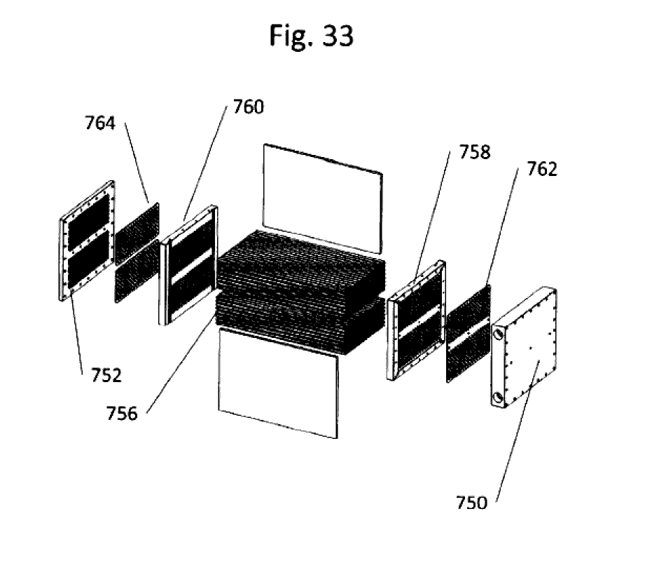

In another embodiment, a carrier liquid distribution manifold is used instead of filling the membrane array, as seen in FIG. 5. Turning to FIG. 32, there is provided a manifold block 750, and a return manifold block 752, which are placed at either end of scrubber 754 which incorporates membrane array 756. Between membrane array 756 and manifold block 750 is a tube sheet 758; between membrane array 756 and return manifold block 752 is a second tube sheet 760. These are illustrated in exploded view in FIG. 33, which also shows manifold gaskets 762 and return manifold gaskets 764.

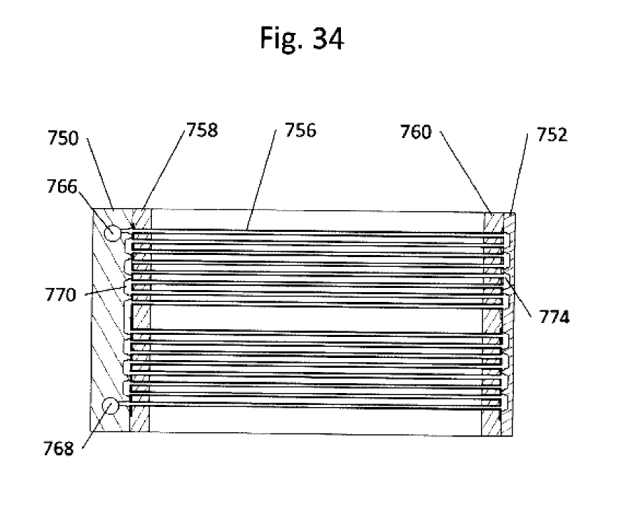

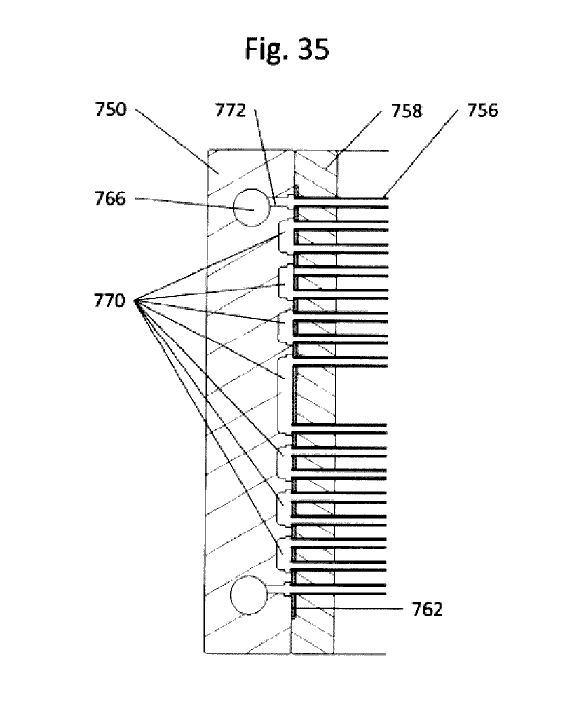

A cross-section of this apparatus in FIG. 32 may be seen in FIG. 34. Turning to FIG. 34, the ceramic membranes in the cross-section in array 756 are connected in series. The carrier enters through inlet 766 and exits through outlet 768. Turning to FIG. 35, the ceramic membranes are connected through gaskets 762 which feed through the tube sheet 758 and pockets 770. Pockets 770 are recesses in manifold block 750. Inlet 766 runs the length of manifold block 750, and is connected to multiple feed pipes 772. Feed pipes 772 do not have to be on the centre line of inlet 766.

Return manifold block 752 has a complementary set of recesses 774 to enable serial flow though the ceramic membranes as seen in FIG. 34, along with complementary gaskets 764 and tube sheet 760.

The use of serial flow as opposed to filling a membrane array via one large manifold (as seen in FIG. 5) has advantages; since the membrane arrays fill in a serial manner from the top, the ceramic membranes will all have flowing carrier inside them, even when there is an overall low flow rate.

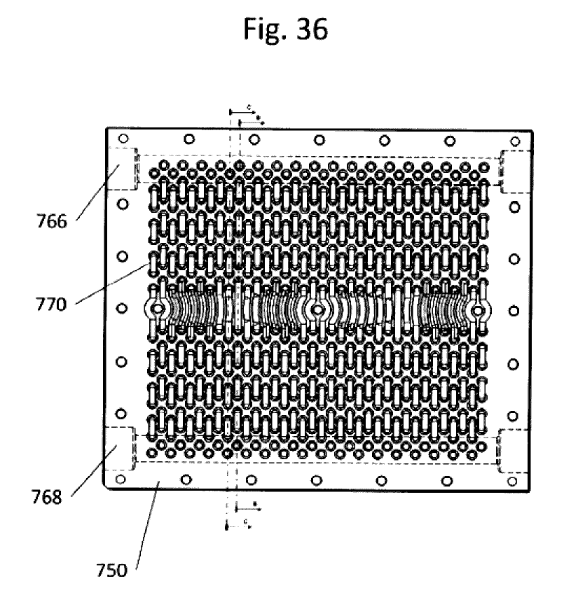

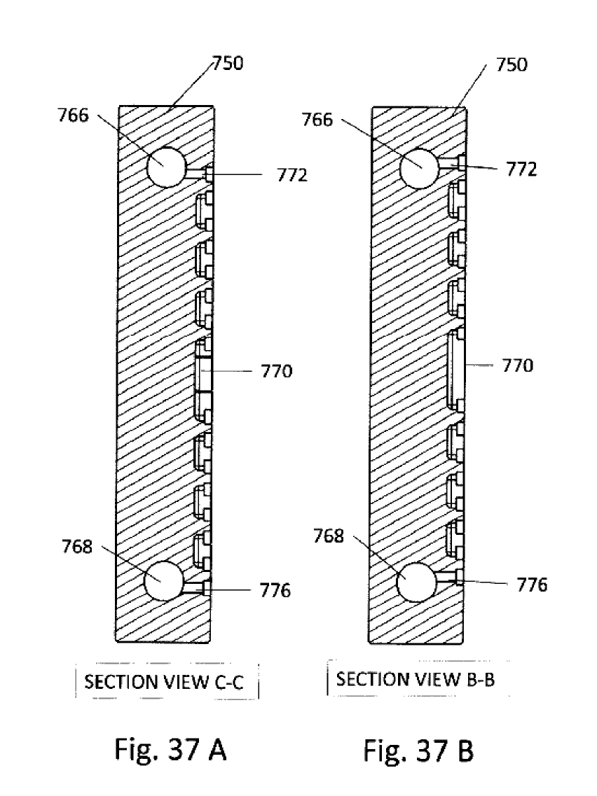

FIG. 36 shows manifold block 750 from an end view, showing the inner surface. The recesses 770 in FIG. 36 facilitate 36 series of ceramic membranes connected as seen in FIG. 34. FIGS. 37a and 37b show a section view along C-C and B-B in FIG. 36. The upper part of FIG. 37B is illustrated as FIG. 35. Turning to FIG. 37B, the carrier enters through inlet 766, passes through the set of ceramic membranes in series, and then exits through outlet 768. Outlet 768 runs the length of manifold block 750, and is attached to multiple feed pipes 776. Feed pipes 776 do not have to be on the centre line of outlet 768.

As may be seen in FIGS. 37A and 37B, the recesses 770 need not be of uniform length. This would allow, for example, for the placement of screw holes in the manifold block 750, as may be seen in FIG. 36.

By having feed pipes 772 and 776 not on the centre line of inlet 766 and outlet 768, the ceramic membranes may be more tightly packed, for example in a diamond pattern that may be seen in FIG. 36. Note that feed pipes 772 and 776 in FIG. 37A are offset from feed pipes 772 and 776 in FIG. 37B to allow for an increased density of ceramic membranes (i.e. the diamond shape configuration versus a square configuration).

Series connections between the ceramic membranes may also be implemented using 180 degree (u-shaped) elbow fittings, and such constructions are an alternative embodiment. However, the use of recesses 770 and 774 also allows for tighter packing of the ceramic membranes as opposed to the use of externally mounted 180 degree elbow fittings, and will typically be less expensive to manufacture, install and maintain, with fewer numbers of pieces in the assembly, reducing the number of components in the overall assembly. For the configuration shown in FIG. 36, the use of manifold black 750 and return manifold block 752 replace over 500 individually mounted 180 degree (u-shaped) elbow fittings.

The manifold block 750 and return manifold 752 may be machined from solid, injection molded, compression or rotor molded, or stamped, or 3d-printed (or manufactured by other methods known to a person skilled in the art), and may be made of a wide range of materials that are rated for (i.e. not attacked or degraded by) the carrier in use (including at the temperatures that will be encountered in use). Similarly, the gaskets and tube sheets should be made from materials that are rated for (i.e. not attacked or degraded by) the carrier in use (including at the temperatures that will be encountered in use).

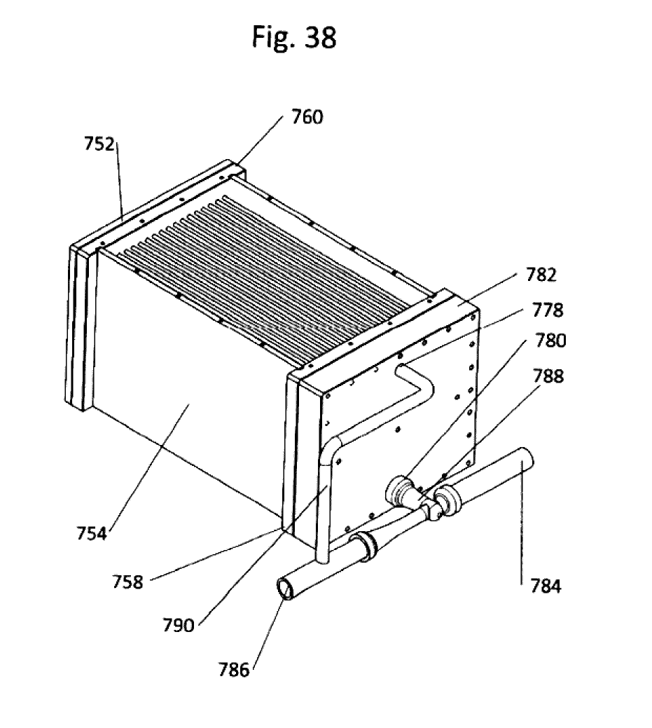

As illustrated in FIGS. 32 to 37B, the inlet 766 and outlet 768 run the length of manifold block 750. However, the inlet port and outlet port may be located in any configuration at the top and bottom of manifold block 750. For example, turning to FIG. 38, inlet port 778 and outlet port 780 are located on the external front face of manifold block 782. Manifold block 782 can otherwise be identical to manifold block 750.

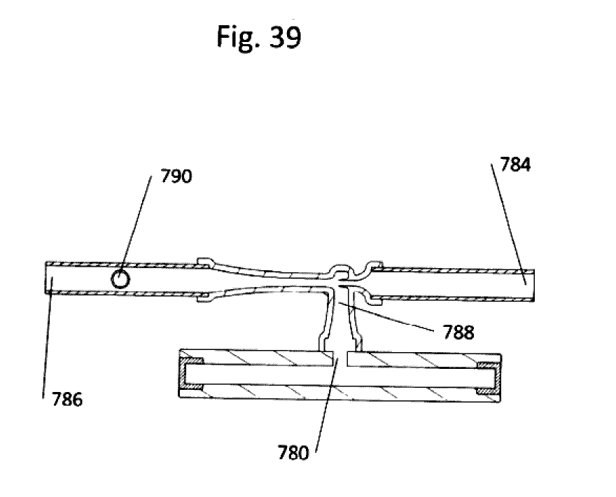

As described above, pumps may be used to pump carrier out of outlet 768. Pumps may be used to pump carrier into inlet 766 as long as a negative pressure is maintained between inlet 766 and outlet 768. In an alternative embodiment, an eductor (or venturi or ejector) is used in replacement for this pump(s) to draw carrier through the membrane array. Note that the use of an eductor (or venturi or ejector) guarantees that there will be a negative pressure between inlet 766 and outlet 768, or across membrane array 756. Turning to FIGS. 38 and 39, carrier liquid is supplied at high pressure to eductor inlet 784 and exits at eductor outlet 786. A layer of relatively low pressure is created inside eductor suction inlet 788, which draws carrier up eductor feedback conduit 790 into inlet 766. At steady state (assuming a constant flow and pressure through eductor inlet 784 and eductor outlet 786), there will be a constant flow of carrier through the membrane array 756 with a negative pressure between inlet 766 and outlet 768. The flow rate of carrier through the membrane array 756 may be controlled by controlling the pressure and flow rate through eductor inlet 784 and outlet 786.

The use of eductors instead of vacuum pumps is advantageous because there is a guarantee of negative pressure (it cannot fail), and the negative pressure is generated right at the membrane array. Instead of multiple vacuum pumps serving multiple membrane arrays through long sections of pipe, a single high power pressure pump can service many membrane arrays with multiple eductors. Perhaps of greatest importance, a single pressure pump (centrifugal pump) can replace multiple vacuum pumps (or vane or piston pumps); and since vacuum pumps are more likely to break or require frequent maintenance than pressure pumps, this will result in maintenance savings and greater reliability of the unit. The use of eductors will also result in ease of installation.

The invention is not intended to be limited to the embodiments described herein, but rather the invention is intended to be applied widely within the scope of the inventive concept as defined in the specification as a whole including the appended claims.

1. A method for reducing the concentration of SO₂ from a source of engine exhaust gas comprising the steps of:
directing said engine exhaust gas from a first engine into an enclosed space containing at least one array of hollow fibre semi-permeable ceramic membranes, wherein said exhaust gas contacts an exterior surface of said membranes whereupon SO₂ within said exhaust gas permeate through said membrane thereby lowering the concentration of said SO₂ within said exhaust gas;
circulating an aqueous NaOH carrier liquid capable of retaining said TEG through bores of said hollow fibre ceramic membranes thereby creating Na₂SO₃ and Na₂SO₄ within said carrier liquid to create an exit liquid;
discharging said exhaust gas containing a reduced SO₂ concentration from the enclosed space and removing said exit liquid containing said Na₂SO₃ and Na₂SO₄ therein from said hollow fibre ceramic membrane array;
using an electrolyzer to convert the exit liquid into regenerated aqueous NaOH and aqueous H₂SO₄; and
recirculating the regenerated aqueous NaOH through the bores of said hollow fibre ceramic membranes.

2. The method of claim 1, where negative pressure is applied to draw the exit liquid from the hollow fibre ceramic membrane array.

3. The method of claim 2, where the step of using an electrolyzer to convert the exit liquid into regenerated aqueous NaOH and aqueous H₂SO₄ also generates hydrogen gas and oxygen gas, and comprising the additional step of injecting the hydrogen gas, the oxygen gas, or both the hydrogen and oxygen gas into a second engine.

4. The method of claim 3, where first engine and the second engine are the same engine.

5. The method of claim 2, where the comprising the further step of using the aqueous H₂SO₄ to pre-treat marine heavy fuel oil before the marine heavy fuel oil is used as a fuel in a ship's engine.

6. The method of claim 5, where step of pre-treating the marine heavy fuel oil comprises the mixing the aqueous H₂SO₄ and marine heavy fuel oil in a mixer that is configured to facilitate soot removal.

7. The method of claim 6, where the mixer is configured to remove sludge from the mixer and store the sludge in a sludge tank.

8. The method of claim 7, where the amount of water in the exit liquid is adjusted by changing the temperature of the aqueous NaOH carrier liquid entering said bores.

9. The method of claim 1, where the step of using an electrolyzer to convert the exit liquid into regenerated aqueous NaOH and aqueous H₂SO₄ comprises the steps of:
using a cooling device to cool the exit liquid to a first temperature and extract crystals of Na₂SO₄ from the exit liquid; and
using an electrolyzer to convert aqueous crystals of Na₂SO₄ into regenerated aqueous NaOH and aqueous H₂SO₄.

10. The method of claim 9, where the first temperature is between around 20 and around 45 degrees Celsius.

11. The method of claim 10, where the first temperature is around 35 degrees Celsius.

12. The method off claim 1, where upon initialization of the method the concentration of NaOH in the aqueous NaOH carrier liquid is around 13 weight percent.

13. A method for reducing the concentration of a target emission gas (TEG) from a source of engine exhaust gas comprising the steps of:
directing said engine exhaust gas from the source into an enclosed space containing at least one array of hollow fibre semi-permeable ceramic membranes,
wherein an electrostatic charge is applied to said exhaust gas,
and then said exhaust gas contacts an exterior surface of said membranes whereupon TEG compounds within said exhaust gas permeate through said membrane thereby lowering the concentration of said TEG within said exhaust gas;
circulating a first carrier capable of retaining said TEG through bores of said hollow fibre ceramic membranes thereby elevating the concentration of TEG compounds within said first carrier;
discharging said exhaust gas containing a reduced TEG concentration from the enclosed space and removing said first carrier containing said TEG compounds therein from said hollow fibre ceramic membrane.

14. The method of claim 13, further comprising the step of spraying a second carrier into the exhaust gas.

15. The method of claim 14, wherein the second carrier is aqueous NaOH or aqueous KOH.

16. The method of claim 13, where the ceramic membranes are connected in series through the use of a manifold block and return manifold block containing recesses to connect the bores of the ceramic membranes.

17. A method for reducing the concentration of a target emission gas (TEG) from a source of engine exhaust gas comprising the steps of:
directing said engine exhaust gas from the source into an enclosed space containing at least one array of hollow fibre semi-permeable ceramic membranes,
wherein a pulsed corona is applied to said exhaust gas,
and then said exhaust gas contacts an exterior surface of said membranes whereupon TEG compounds within said exhaust gas permeate through said membrane thereby lowering the concentration of said TEG within said exhaust gas;
circulating a first carrier capable of retaining said TEG through bores of said hollow fibre ceramic membranes thereby elevating the concentration of TEG compounds within said first carrier;
discharging said exhaust gas containing a reduced TEG concentration from the enclosed space and removing said first carrier containing said TEG compounds therein from said hollow fibre ceramic membrane.

18. The method of claim 17, further comprising the step of spraying a second carrier into the exhaust gas.

19. The method of claim 18, wherein the second carrier is aqueous NaOH or aqueous KOH.

20. The method of claim 17, where the ceramic membranes are connected in series through the use of a manifold block and return manifold block containing recesses to connect the bores of the ceramic membranes.
